(19) United States
(12) Patent Application Publication
(10) Pub. No.: US 2017/0248896 A1
(43) Pub. Date: Aug. 31, 2017

(54) IMAGE FORMING APPARATUS

(71) Applicants: Naoki NAKATAKE, Hyogo (JP); Takeshi YAMASHITA, Osaka (JP); Tetsushi SAKUMA, Osaka (JP); Mitsutoshi KICHISE, Osaka (JP); Tsuyoshi NOZAKI, Osaka (JP); Yoshihiro MIKURIYA, Hyogo (JP); Yoshimichi ISHIKAWA, Hyogo (JP); Atsushi YAMAMOTO, Osaka (JP); Kazuoki FUWA, Hyogo (JP); Tomohiro FUKAO, Osaka (JP); Tomoharu MIKI, Osaka (JP)

(72) Inventors: Naoki NAKATAKE, Hyogo (JP); Takeshi YAMASHITA, Osaka (JP); Tetsushi SAKUMA, Osaka (JP); Mitsutoshi KICHISE, Osaka (JP); Tsuyoshi NOZAKI, Osaka (JP); Yoshihiro MIKURIYA, Hyogo (JP); Yoshimichi ISHIKAWA, Hyogo (JP); Atsushi YAMAMOTO, Osaka (JP); Kazuoki FUWA, Hyogo (JP); Tomohiro FUKAO, Osaka (JP); Tomoharu MIKI, Osaka (JP)

(21) Appl. No.: 15/329,843

(22) PCT Filed: Jul. 17, 2015
(86) PCT No.: PCT/JP2015/003606

§ 371 Date: Jan. 27, 2017

(30) Foreign Application Priority Data
Jul. 31, 2014 (JP) 2014-156694

(51) Int. Cl. G03G 21/00; G03G 21/18; G03G 9/097

(52) U.S. Cl. CPC G03G 21/0011; G03G 9/09725; G03G 21/1814

(57) ABSTRACT

Image forming apparatus, including: image bearer; charging unit for electrically charging image bearer surface; developing unit for developing with toner, electrostatic latent image formed over image bearer by exposure unit for performing light exposure; transfer unit for transferring developed toner to receiving member; and cleaning unit for cleaning toner remaining over image bearer without being transferred, wherein the toner contains: external additives; and base particles made of at least binder resin and colorant, external additive content of the toner is from 4 to 7 parts by mass relative to 100 parts by mass of base particles, primary particles of at least one external additive have a number average particle diameter of 0.01 to 0.05 μm, cleaning unit includes an elastic-body blade having surface elastic modulus of from 15 to 25 N/mm² and surface friction coefficient of from 0.5 to 0.7 at an abutment part thereof abutting on image bearer.

### TECHNICAL FIELD

The present invention relates to an image forming apparatus.

### BACKGROUND ART

Many image forming apparatuses such as copiers, printers, or facsimile machines that are configured to form an electrostatic latent image over an image bearer and develop the electrostatic latent image to a visible image with a developer to thereby obtain a recorded image employ a dry developing device that uses a powder toner as a developer (or as part of a developer).

Further, recent popularization of electrophotographic color image forming apparatuses and easy availability of digitalized images have led to demands for printed images with a higher definition.

Hence, there are studies for pursuing a higher resolution and a higher gray level property in an image, among which is a study for making toner particles more spherical and smaller in diameter for forming a high-definition image, as an improvement of the toner for visualizing an electrostatic latent image. A toner produced by a pulverization method has limitations in these properties, and there hence has been already known a so-called polymerization toner that is produced by a suspension polymerization method, an emulsion polymerization method, a dispersion polymerization method, etc. that can make particles spherical and small in diameter.

Meanwhile, examples of a cleaning unit used commonly in a cleaning step in an electrophotography process include one that is obtained by bonding a flat-plate-shaped blade member made of a urethane rubber or the like to a supporting member formed of a sheet metal in a longitudinal direction. In this cleaning unit, an end portion of the blade member that is opposite to a bonded portion thereof bonded to the supporting member is forced to abut on the surface of an image bearer under a predetermined pressure, such that while being elastically deformed, the blade member forms a blade nip portion between the surface of the image bearer and the blade member, and slidingly rubs the surface of the image bearer. When the surface of the image bearer is slidingly rubbed, a residual toner or a foreign matter over the surface of the image bearer is removed and collected. Generally, such a cleaning method is widely known as a blade cleaning method.

Here, PTL 1 discloses that an impact resilience of the elastic-body blade as the cleaning unit is prescribed to a range of from 19% to 43%, that a surface layer harder than the elastic-body blade is provided through a surface treatment, and that a friction coefficient of a leading end edge portion is prescribed to 0.5 or lower, in order for a cleaning ability under low-temperature conditions to be secured.

However, when a surface layer harder than the elastic-body blade is provided as in PTL 1, wearing of the image bearer may be promoted when the image bearer is slidingly rubbed (durability of a passed sheet may be degraded), if a microhardness of a portion of the surface layer that contacts the image bearer is too high. Hence, with the technique disclosed in PTL 1, the life span of the member may be shortened, and an edge portion of the blade may become brittle to incur troubles such as a crack or a flaw of the edge, which may greatly degrade the toner cleaning ability.

Conversely, if the microhardness of the surface layer is too low due to an insufficient surface treatment, the ability to scrape off a filming material over the image bearer is poor, which may bring about a cleaning failure due to breakage of the blade edge at the filmed portion of the image bearer.

As described above, the hardness of the surface treatment layer has a significant influence on the cleaning, which makes it necessary to control the surface treatment layer.

In a unit configured to form a surface treatment layer over the elastic-body blade, what determines the hardness of micro regions of the surface treatment layer is the physical properties of the treatment material, which makes it likely for the hardness to be rather a bit too high. Hence, it can be easily estimated that the likelihood of occurrence of troubles such as wearing of the image bearer described above is high. This allows selection of only a material having a relatively low rubber hardness of from 70° to 75°, which may make it impossible to secure an abutting pressure required as a cleaning blade.

### CITATION LIST

### Patent Literature

PTL 1: Japanese Patent Application Laid-Open (JP-A) No. 2010-210879

### SUMMARY OF INVENTION

### Technical Problem

The present invention was made in view of the problems of the conventional art described above, and an object of the present invention is to provide an image forming apparatus that can provide high-quality images by suppressing cleaning failures under various conditions of use.

### Solution to Problem

An image forming apparatus according to the present invention for solving the problems described above includes:

an image bearer;

a charging unit configured to electrically charge a surface of the image bearer;
a developing unit configured to develop with a toner, an electrostatic latent image formed over the image bearer by an exposure unit configured to perform light exposure;
a transfer unit configured to transfer the developed toner to a receiving member; and
a cleaning unit configured to clean a residual toner of the toner remaining over the image bearer without being transferred,
wherein the toner contains: one or more external additives; and base particles made of at least a binder resin and a colorant,
wherein a content of the one or more external additives is from 4 parts by mass to 7 parts by mass relative to 100 parts by mass of the base particles,
wherein primary particles of at least one of the one or more external additives have a number average particle diameter of from 0.01 μm to 0.05 μm,
wherein the cleaning unit includes an elastic-body blade, and
wherein the elastic-body blade has a surface elastic modulus of from 15 N/mm² to 25 N/mm² and a surface friction coefficient of from 0.5 to 0.7 at an abutment part thereof abutting on the image bearer.

### Advantageous Effects of Invention

The present invention can provide an image forming apparatus that can provide high-quality images by suppressing cleaning failures under various conditions of use.

### BRIEF DESCRIPTION OF DRAWINGS

FIG. 1 is a schematic cross-sectional diagram showing a configuration of an image forming apparatus of the present invention in one embodiment.

FIG. 2 is a schematic enlarged diagram showing a configuration of a process cartridge of an image forming apparatus of the present invention in one embodiment.

FIG. 3 is a schematic cross-sectional diagram showing a configuration of a developing device of FIG. 2.

FIG. 4 is a schematic enlarged diagram showing a configuration of a cleaning device of an image forming apparatus of the present invention in one embodiment.

FIG. 5 is a schematic enlarged diagram of an abutment part between a cleaning blade and a photoconductor of FIG. 4.

FIG. 6 is a SEM image of one example of a toner used in the present invention.

FIG. 7 is a diagram explaining a method for calculating a coverage by protrusions over a toner particle in the present invention.

### DESCRIPTION OF EMBODIMENTS

An image forming apparatus of the present invention includes: an image bearer; a charging unit configured to electrically charge a surface of the image bearer; a developing unit configured to develop with a toner, an electrostatic latent image formed over the image bearer by an exposure unit configured to perform light exposure; a transfer unit configured to transfer the developed toner to a receiving member; and a cleaning unit configured to clean a residual toner of the toner remaining over the image bearer, wherein the toner contains: one or more external additives; and base particles made of at least a binder resin and a colorant, wherein the content of the one or more external additives is from 4 parts by mass to 7 parts by mass relative to 100 parts by mass of the base particles, wherein primary particles of at least one of the one or more external additives have a number average particle diameter of from 0.01 μm to 0.05 μm, wherein the cleaning unit includes an elastic-body blade, and wherein the elasticbody blade has a surface elastic modulus of from 15 N/m² to 25 N/m² and a surface friction coefficient of from 0.5 to 0.7 at an abutment part thereof abutting on the image bearer.

External additives are added to the toner base particles in order to add to chargeability of the toner and overcome a background smear. When an external additive made of a small particle diameter component is added in a large amount, an effect of suppressing a background smear is high because a large surface area can be obtained. However, because of its small particle diameter, such an external additive is poorly cleanable, and is a cause of a defective image such as a streak due to a cleaning failure. Hence, the configuration of the present invention described above is employed as an elasticbody blade, (1) which makes it possible to suppress stick-slip due to sliding rubbing between the image bearer and the elastic-body blade, and hence to form a toner dammed layer stably, and (2) which provides a high surface elastic modulus, and a high scraping ability of scraping the surface of the image bearer, leading to improvement of the image bearer cleaning ability.

Based on the factors described above, it is possible to provide an image forming apparatus that can form favorable images for a long term.

Here, the mechanism of the present invention will be further described prior to the description of the present invention.

As the result of conducting earnest studies from a viewpoint of surface properties and a favorable cleaning ability of the elastic-body blade, the present inventors have discovered that a surface elastic modulus of the elastic-body blade is greatly influential in this relation.

In order to perform toner cleaning, it is indispensable that an accumulated layer of the toner and the external additives be present near a nip between a cleaning blade (elastic-body blade) and the image bearer (photoconductor) on the upstream side of the nip.

The cleaning unit of the present invention is constructed by including the elasticbody blade, and the elastic-body blade has a surface elastic modulus of from 15 N/mm² to 25 N/mm² and a surface friction coefficient of from 0.5 to 0.7 at an abutment part thereof abutting on the image bearer. With the cleaning unit having this configuration, a frictional force between the cleaning unit and the image bearer and vibrations can be suppressed under various conditions of use, which makes it possible to form an accumulated layer more firmly, and to consequently suppress cleaning failures.

Further, according to the present invention, even when the content of external additives (e.g., silica) of the toner used for image formation is from 4 parts by mass to 7 parts by mass relative to 100 parts by mass of the toner base, it is possible to prevent a solid image from having an image defectiveness due to filming of the external additives over the image bearer.

Even when the additive amount of the external additives is increased in order to ensure the toner a sufficient chargeability, the cleaning unit of the present invention can simultaneously satisfy slidability with the image bearer (photoconductor) and a scraping ability of scraping the surface of the image bearer based on an adequate surface elastic modulus. Hence, according to the present invention, no cleaning failure will occur, and there is an effect of making it possible to greatly suppress the possibilities of filming growth, by scraping off filming over the image bearer due to slip-through and accumulation of minute external additives that could not be prevented by a cleaning blade.

A poorly charged toner contains a weakly-charged or reversely-charged toner components. At the electric potential of the image bearer in an image unformed region thereof, a toner supporting member (e.g., a developing roller) cannot retain these toner components. Then, these weakly-charged or reversely-charged toner components adhere to the surface of the image bearer, which not only worsens the toner consumption efficiency due to unnecessary toner consumption, but also makes it impossible to obtain a favorable image quality because the adhered toner, if too much, will be visibly perceived as a smear in the background region of an image.

Hence, in order for the toner to be assisted in chargeability, external additives having a smaller particle diameter than the toner, such as silica for imparting chargeability, are added and attached to the toner base, to thereby improve chargeability of the toner on the whole and overcome the troubles.

However, such an external additive has a very small particle diameter, and cannot be cleaned with a conventional cleaning blade and slips through the blade, which leads to a cleaning failure, or breakage of the blade due to filming of the slipped-through external additive over the image bearer.

Hence, the surface friction coefficient of the cleaning blade of the present invention is set to the range described above, which can stabilize an edge behavior of the blade that accompanies a dynamic contact between the surface of the image bearer and the abutment part of the blade, which provides a significant functional improvement against slip-through of an external additive. Further, the surface elastic modulus of the cleaning blade of the present invention is set to the range described above, which significantly improves the ability to scrape the image bearer, and provides a great effect in filming suppression.

Further, according to the present invention, a sufficient cleaning ability can be secured even when the amount of the external additive is set to such an amount at which chargeability of the toner can be secured sufficiently. Hence, improvement of the toner consumption efficiency and a favorable image quality can be realized at the same time for a long term.

<<Image Forming Apparatus>>

An image forming apparatus of the present invention will be described below in more detail with reference to the drawings.

Embodiments described below are preferred embodiments of the present invention, and hence limited in various technically favorable manners. However, the scope of the present invention is not limited to these embodiments unless the following description includes a mention to the effect that the present invention is limited to them.

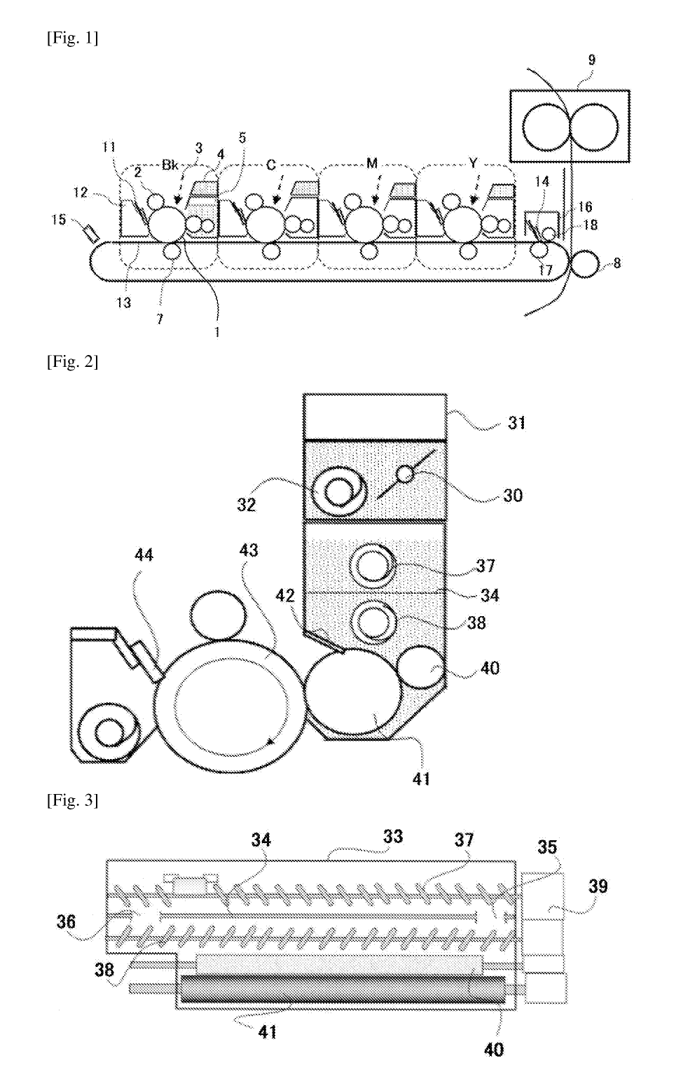

FIG. 1 is a schematic diagram showing a configuration of an image forming apparatus of the present invention in one embodiment. The embodiment of the image forming apparatus shown in FIG. 1 is an example of a so-called tandem image forming apparatus.

In a manner to surround a drum-shaped photoconductor 1, which is an image bearer, a charging device 2 as a charging unit configured to electrically charge a surface of the drum, light exposure 3 formed of a laser light beam for forming an electrostatic latent image over the electrically charged surface that is emitted from an exposure unit, a developing device 5 as a developing unit configured to form a toner image by attaching an electrically charged toner to the electrostatic latent image over the surface of the drum, a transfer device 7 as a transfer unit configured to transfer the formed toner image over the drum to a receiving member (a transfer belt 13), and a cleaning device 12 as a cleaning unit configured to remove a residual toner over the drum are arranged in this order. A replaceable toner supply container 4 containing a toner is provided above the developing device 5, and is jointed to the developing device and supplies the toner into the developing device.

The toner supply container 4 shown here has a configuration for conveying the toner directly into the developer container. However, it may have a configuration for supplying a toner into the developer container through a supply path provided in the body of the image forming apparatus.

In a tandem electrophotographic system, principally, single-color images having, for example, a black (Bk) color, a cyan (C) color, a magenta (M) color, and a yellow (Y) color are formed over the surface of the photoconductor 1. The regions enclosed by the broken lines constitute image forming units (process cartridges) corresponding to the respective colors. With this configuration, an image formation according to a negative-positive method (i.e., a method of attaching a toner to an exposed portion by lowering the electric potential of the exposed portion) is performed in a manner that the surface of the photoconductor 1 is electrically charged negatively uniformly with a charging roller of the charging device 2, an electrostatic latent image is formed over the surface of the photoconductor 1 by the light exposure 3, and the toner is attached to the surface of the photoconductor 1 by the developing device 5 to visualize the electrostatic latent image.

The image visualized with the toner is transferred from the surface of the photoconductor 1 by the transfer belt 13 and the transfer device 7, and a residual toner component remaining untransferred from the photoconductor 1 to the transfer belt 13 is removed from the surface of the photoconductor 1 by a cleaning blade 11 of the cleaning device 12.

The toner image transferred to the surface of the transfer belt 13 is transferred to a recording sheet conveyed from a paper feeding tray (unillustrated) with a bias applied to a second transfer roller 8 at a second transfer unit.

A residual toner component or external additive component after the second transfer is removed by a transfer belt cleaning device 16. The transfer belt cleaning device 16 includes a metallic cleaning facing roller 17, a transfer belt cleaning blade 14 made to abut on the belt in a direction counter to the moving direction of the belt, and a collecting roller 18, and cleans away a residual toner component or external additive component over the transfer belt 13 and stores it in an unillustrated waste toner storage unit.

The toner image transferred to the recording sheet is fusion-fixed on the recording sheet as a fixed image, and ejected through an unillustrated paper ejection port.

A sensor 15 is provided near the transfer belt 13, and used for measurement of a deposition amount of the toner transferred to the transfer belt 13 and the position of each color for image density adjustment and positional alignment. The sensor 15 is system in which specular and diffuse reflection schemes are combined.

<Process Cartridge Portion>

Next, the configuration around the photoconductor of the image forming apparatus will be further described.

FIG. 2 is a schematic enlarged diagram showing a configuration of a process cartridge of the image forming apparatus of the present invention in one embodiment. FIG. 3 is a schematic cross-sectional diagram showing a configuration of a developing device of FIG. 2.

A toner storing container 31 is jointed to a developing device 33. It is preferable to stir the internal space of the toner storing container constantly with a stirring paddle 30 or the like in order to maintain the flowability of the toner. In the toner storing container 31, a toner can be conveyed by a conveying unit 32 such as a screw or a coil to a toner supply port that is located at a joint portion at which the toner storing container is jointed to the developing device or a toner supply path in the image forming apparatus (hereinafter, the description will be based on the configuration that the toner is supplied directly into a developer container). The conveying unit 32 can be jointed to an unillustrated main body drive section. The main body drive section and the conveying unit can be controlled to be jointed to or disjointed from each other by a publicly-known means such as a clutch, such that they can be driven to supply the toner when necessary.

A toner supply amount can be controlled by means of a drive time for which the drive section is driven. For example, a control manner of changing the drive time adaptively to changes of the flowability of the toner due to temperature and humidity conditions is possible.

In the developing device 33, there is a divider plate 34 that is situated in the axial direction of a developing member and can make the internal space of the developing device dividable, and there are opening portions 35 and 36 at at least both ends of the divider plate 34 in the longer direction of the divider plate to make the toner movable to and from between an upper tank and a lower tank. The toner supplied into the developing device from the toner supply container as described above can be conveyed in the axial direction of a developing member 41 by a first toner conveying unit 37 situated in the upper tank and composed of a screw or the like, move to the lower tank through the opening portion at the downstream side in the conveying direction, and be conveyed in the axial direction of the developing member by a second toner conveying unit 38 situated in the lower tank and likewise composed of a screw or the like in the opposite direction from the direction of conveying by the first toner conveying unit 37. The toner can move to the upper tank through the opening portion of the divider plate at the downstream side of the second toner conveying unit. Hence, the toner in the developing device can be circulated therein in the longer direction thereof.

A toner conveying speed can be controlled by means of the configuration of the conveying members. When a screw member is used, the toner conveying speed increases in proportion to the screw pitch. This is because the amount of toner conveyed per rotation of the screw increases. The toner conveying speed can also be controlled by increasing the screw diameter.

Driving can be transmitted to the first and second toner conveying units from a drive source situated in the body of the image forming apparatus or the like through a drive transmission unit 39 composed of a gear, a coupling, or the like. The toner in the developing device can move to the developing member 41 through a toner supply member 40 composed of a sponge or the like through which the toner can be supplied to the developing member 41.

The toner moved to the developing member 41 through the toner supply member 40 is made into a uniform toner layer to be deposited on the developing member 41 by a regulating member 42. After this, an amount of the toner corresponding to the surface potential of a photoconductor drum 43 moves to the surface of the photoconductor drum 43, and is transferred to a receiving member (a transfer belt) by an unillustrated transfer unit. As described above, a residual toner of the toner moved to the photoconductor drum 43 that remains over the photoconductor untransferred is removed by a cleaning unit 44, and collected in a waste toner storing container provided in the image forming apparatus.

<Cleaning Device>

Next, a cleaning device will be described.

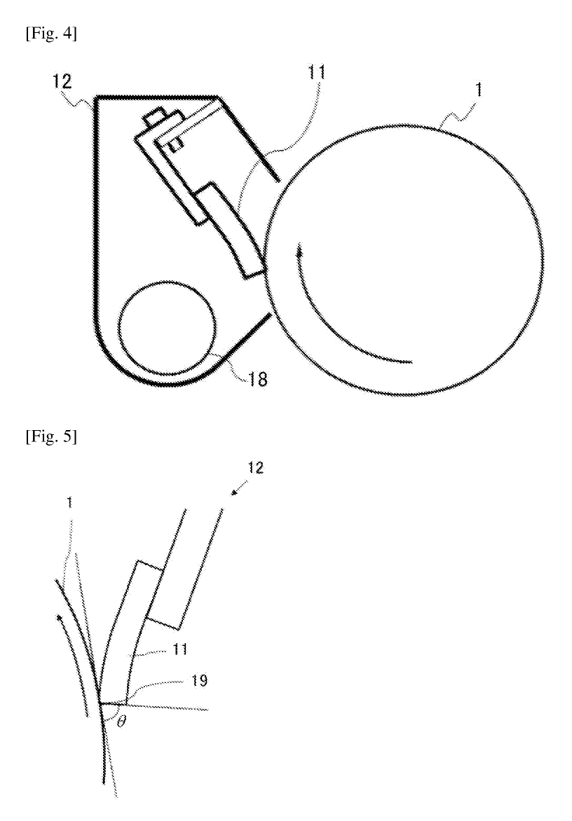

FIG. 4 is a schematic enlarged diagram showing a configuration of a cleaning device of the image forming apparatus of the present invention in one embodiment. FIG. 5 is a schematic enlarged diagram of an abutment part between a cleaning blade and a photoconductor of FIG. 4.

A cleaning device 12 is mainly composed of an elastic-body blade 11 produced by bonding a blade made of an elastic material such as polyurethane to a supporting member made of a metal such as SUS. The cleaning device can clean the surface of the photoconductor 1 by making a leading end of the elastic-body blade 11 abut on the photoconductor 1 in a counter direction and scrape off a toner attached on the photoconductor or any other attached matter.

As the material of the elastic-body blade 11, elastic materials such as a neoprene rubber, a chloroprene rubber, a silicon rubber, and an acrylic rubber may be used. However, a cleaning blade made of a polyurethane rubber that does not damage the photoconductor chemically and is excellent in durability, ozone resistance, oil resistance, etc. is preferable. A rubber hardness of the elastic-body blade expressed in JIS-A hardness is preferably from 76° to 82°. It is preferable if the rubber hardness of the elastic-body blade expressed in JIS-A hardness is within this range, because a surface elastic modulus of the elastic-body blade can be set high, which improves the scraping ability.

When the rubber hardness is greater than 82°, the elastic-body blade has a poor flexibility and tends to have a so-called uneven abutting, which may make it harder for the abutting pressure to be even in the axial direction. On the other hand, when the rubber hardness is less than 76°, it becomes harder for the cleaning blade and the photoconductor to have a required pressing force against each other. Hence, when the elastic-body blade is made to bite to a greater degree in order to secure the pressing force, a leading end edge portion of the blade floats upward to thereby cause a so-called belly abutting phenomenon.

The supporting member is screwed to a case (housing) of an image forming unit, and the leading end of the elastic-body blade 11 is made to abut on the photoconductor 1. Here, it is preferable that an angle θ formed between a tangent line on the surface of the photoconductor 1 (a tangent line parallel with the direction of rotation) and a leading end surface 19 of the elastic-body blade 11 when they are abutting be set to 77° to 82°, because the elastic-body blade would not have troubles such as squealing or ride-up.

When the angle θ is less than 77°, there may occur a large edge behavior at the leading end portion of the blade at the point abutting on the photoconductor, which may make a toner dammed layer unstable and cause a cleaning failure. Further, there are higher possibilities that a defective image may be produced due to the cleaning failure, and that the blade edge may ride up by following the photoconductor.

On the other hand, when the angle θ is greater than 82°, the elastic-body blade cannot have the edge thereof abut firmly on the photoconductor, but has the belly thereof abut thereon, which may be the cause of a cleaning failure.

The abutting pressure (linear pressure) of the cleaning blade on the image bearer can be measured with a pressure sensor mounted on a surface position of the photoconductor. The abutting pressure is preferably from 30 N/m to 70 N/m. In this range, the cleaning blade can secure a close contact with the image bearer, by the leading end of the elastic-body blade abutting on the image bearer at a sufficiently high pressure.

When the abutting pressure (linear pressure) is lower than 30 N/m, the cleaning blade cannot have a sufficient toner blocking force due to its poor contact pressure, which may be the cause of a cleaning failure. On the other hand, when the abutting pressure (linear pressure) is higher than 70 N/m, a too high contact pressure may cause troubles such as chattering, and a greater torque is required to drive the photoconductor, which necessitates a motor having a proportionally higher capacity, which is disadvantageous in an economic aspect.

A surface friction coefficient and a surface elastic modulus of the rubber material of the cleaning blade (elastic-body blade 11) can be controlled by molding a polyurethane material into a strip shape, immersing it in an isocyanate-based treatment liquid, drying and removing the solvent, and subjecting the elastic-body blade to a surface treatment. However, the present invention is not limited to this, but a treatment with an isocyanate-based treatment liquid may be applied by various publicly-known methods such as spray coating instead of immersing.

The surface friction coefficient of the elastic-body blade is preferably from 0.5 to 0.7. When the surface friction coefficient is greater than 0.7, the elastic-body blade will abut on the photoconductor in a state that the distance to which the blade edge will follow the photoconductor in the direction of rotation will be large, which makes a toner dammed layer unstable, which may be the cause of a cleaning failure. On the other hand, when the surface friction coefficient is less than 0.5, the leading end of the blade may slip, and the cleaning blade cannot have a sufficient toner blocking force due to its poor contact pressure, which may be the cause of a cleaning failure.

A surface elastic modulus of the abutment part abutting on the image bearer is preferably from 15 N/mm² to 25 N/mm².

When the surface elastic modulus is less than 15 N/mm², a sufficient effect cannot be obtained in the ability to scrape the surface of the photoconductor.

On the other hand, when the surface elastic modulus is greater than 25 N/mm², the hardness of the elastic-body blade itself (particularly, when it is a polyurethane blade) will increase and become brittle under low-temperature conditions, which may chip off the blade edge and increase the amount of wear of the photoconductor, leading to a shorter life span of the members. Furthermore, the blade edge will have a too high hardness to have a sufficient close contact with the photoconductor, which may let the toner slip through.

The surface friction coefficient and the surface elastic modulus can be controlled by means of the concentration of the isocyanate-based treatment liquid. By increasing the concentration of the treatment liquid, it is possible to reduce the surface friction coefficient and increase the surface elastic modulus.

(Surface Friction Coefficient)

A surface friction coefficient measuring method according to the present invention will be described.

A weight that is made of SUS and weighs 117 g is put on the elastic-body blade that is molded into a strip shape. Then, the weight is pulled in a horizontal direction with a material having a small elastic deformation such as a wire that is attached to one end of the weight, and with a digital force gauge attached to the other end thereof, and a resulting pull force is converted to a surface friction coefficient according to F=μN. An average taken for a period from 5 sec. to 10 sec. after the weight starts to move is used as the surface friction coefficient.

(Surface Elastic Modulus)

A surface elastic modulus measuring method according to the present invention will be described.

A measured position is included in an abutting surface of the strip-shape-molded elastic-body blade abutting on the photoconductor, and is away from the leading end edge position by 30 μm. A microhardness tester (DUH-211S manufactured by Shimadzu Corporation) is used for the measurement.

<Toner>

A toner of the present invention is an external additive-added or -supporting toner for aiding flowability, developability, chargeability, etc. of the base particles thereof that contain a binder resin and a colorant as indispensable components. The base particles of the toner may contain a release agent, a charge controlling agent, a plasticizer, and other necessary components according to necessity.

(Binder Resin)

Examples of the binder resin include polyester, polyurethane, polyurea, an epoxy resin, and a vinyl-based resin. A hybrid resin in which different kinds of resins are chemically bonded may also be used. Furthermore, reactive functional groups may be incorporated at a terminal or a side chain of a resin, and bonded with each other in the toner production process to thereby elongate the resin. One of the above resins may be used alone, but in order to produce a toner having protrusions for surface profile control, it is preferable that the resin to constitute the toner particles be different from a resin to constitute the protrusions.

As the resin to constitute the base particles, a resin that is at least partially soluble in an organic solvent is used. The acid value of such a resin is preferably from 2 mgKOH/g to 24 mgKOH/g. When the acid value is greater than 24 mgKOH/g, the resin is likely to migrate into an aqueous phase, which may cause problems that a material balance loss occurs in the production process or that oil droplets have a poor dispersion stability. Furthermore, water adsorptivity of the toner will be increased, which may reduce the chargeability of the toner and degrade the storageability of the toner under high-temperature, high-humidity conditions. On the other hand, when the acid value is less than 2 mgKOH/g, the polarity of the resin is reduced, which makes it hard for a colorant having some degree of polarity to be dispersed uniformly in an oil droplet.

The kind of the resin is not particularly limited, but a resin used in an electrostatic latent image developing toner for electrophotography is preferably a resin having a polyester skeleton, because a favorable fixability will be obtained. Examples of the resin having a polyester skeleton includes a polyester resin, and a block polymer between polyester and a resin having another skeleton. A polyester resin is preferred because toner base particles to be obtained will be highly uniform.

Examples of the polyester resin include a product obtained by ring-opening polymerization of a lactone, a product obtained by condensation polymerization of a hydroxycarboxylic acid, and a product obtained by polycondensation of a polyol and a polycarboxylic acid. A product obtained by polycondensation of a polyol and a polycarboxylic acid is preferable in terms of latitude allowed in designing.

A peak molecular weight of the polyester resin is typically from 1,000 to 30,000, preferably from 1,500 to 10,000, and more preferably from 2,000 to 8,000. When the peak molecular weight of the polyester resin is less than 1,000, heat resistant storage stability will be poor. When it is greater than 30,000, low temperature fixability to qualify as an electrostatic latent image developing toner will be poor.

A glass transition temperature of the polyester resin is from 45° C. to 70° C.,

And preferably from 50° C. to 65° C. A glass transition temperature lower than 45° C. is not preferable, because under high-temperature, high-humidity conditions of 40° C. and 90% assumed during shipping of the toner or a toner cartridge, the obtained toner may deform under a certain pressure, or toner particles may fuse with each other, which may deprive the toner of its original behavior as particles. A glass transition temperature of the polyester resin that is higher than 70° C. is not preferable because low temperature fixability will be poor.

(Polyol)

Examples of the polyol (1) includes diol (1-1) and trivalent or higher polyol (1-2). (1-1) alone, or a mixture between (1-1) and a small amount of (1-2) is preferable. Examples of diol (1-1) includes: alkylene glycol (e.g., ethylene glycol, 1,2-propylene glycol, 1,3-propylene glycol, 1,4-butanediol, and 1,6-hexanediol); alkylene ether glycol (e.g., diethylene glycol, triethylene glycol, dipropylene glycol, polyethylene glycol, polypropylene glycol, and polytetramethylene ether glycol): alicyclic diol (e.g., 1,4-cyclohexanedimethanol, and hydrogenated bisphenol A); bisphenols (e.g., bisphenol A, bisphenol F, and bisphenol S); alkylene oxide (e.g., ethylene oxide, propylene oxide, and butylene oxide) adduct of the aforementioned alicyclic diol; 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as: tetrafluorobisphenol A), and 2,2-bis(3-hydroxyphenyl)-1,1,1,3,3,3-hexafluoropropane; bis(4-hydroxyphenyl)ethers such as bis(3-fluoro-4-hydroxyphenyl)ether; and alkylene oxide (e.g., ethylene oxide, propylene oxide, and butylene oxide) adduct of the aforementioned bisphenols.

Among these, alkylene glycol having 2 to 12 carbon atoms, and alkylene oxide adduct of bisphenols are preferable. Alkylene oxide adduct of bisphenols, and a combined use of alkylene oxide adduct of bisphenols and alkylene glycol having 2 to 12 carbon atoms are particularly preferable.

Examples of the trivalent or higher polyol (1-2) includes: trivalent to octavalent or higher multivalent aliphatic alcohol (e.g., glycerin, trimethylolethane, pentaerythritol, and sorbitol); trivalent or higher phenols (e.g., trisphenol PA, phenol novolac, and cresol novolac); and alkylene oxide adduct of the aforementioned trivalent or higher polyphenols.

(Polycarboxylic Acid)

Examples of the polycarboxylic acid (2) include dicarboxylic acid (2-1) and trivalent or higher polycarboxylic acid (2-2). (2-1) alone, or a mixture between (2-1) and a small amount of (2-2) is preferable.

Examples of the dicarboxylic acid (2-1) includes alkylene dicarboxylic acid (e.g., succinic acid, adipic acid, and sebacic acid); alkenylene dicarboxylic acid (e.g., maleic acid, and fumaric acid); aromatic dicarboxylic acid (e.g., phthalic acid, isophthalic acid, terephthalic acid, and naphthalene dicarboxylic acid); and 3-fluoroisophthalic acid, 2-fluoroisophthalic acid, 2-fluoroterephthalic acid, 2,4,5,6,-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyl dicarboxylic acid, 3,3′-bis(trifluoromethyl)-4,4′-biphenyl dicarboxylic acid, 2,2′-bis(trifluoromethyl)-3,3′-biphenyl dicarboxylic acid, and hexafluoroisopropylidene diphthalic anhydride. Among these, alkenylene dicarboxylic acid having 4 to 20 carbon atoms, and aromatic dicarboxylic acid having 8 to 20 carbon atoms are preferable.

Examples of the trivalent or higher polycarboxylic acid (2-2) includes aromatic polycarboxylic acid having 9 to 20 carbon atoms (e.g., trimellitic acid, and pyromellitic acid). An acid anhydride or a lower alkyl ester (e.g., methyl ester, ethyl ester, and isopropyl ester) of those above may be used as the polycarboxylic acid (2) and reacted with the polyol (1).

A ratio between the polyol and the polycarboxylic acid, as expressed in an equivalent ratio [OH]/[COOH] of hydroxyl group [OH] to carboxyl group [COOH] is typically from 2/1 to 1/2, preferably from 1.5/1 to 1/1.5, and more preferably from 1.3/1 to 1/1.3.

(Modified Resin)

In order to enhance a mechanistic strength to be obtained, or in order to prevent hot offset during fixing in addition to enhancement of a mechanistic strength, the base particles may be obtained by dissolving a modified resin having an isocyanate group at a terminal in an oil phase. Examples of the method for obtaining a modified resin includes a method of inducing a polymerization reaction together with a monomer containing isocyanate to thereby obtain a resin having an isocyanate group, and a method of obtaining a resin having an active hydrogen at a terminal by polymerization, and after this, reacting it with polyisocyanate to thereby incorporate an isocyanate group at a terminal of the polymer. It is preferable to employ the latter method because of its controllability of incorporating an isocyanate group at a terminal. Examples of the active hydrogen include a hydroxyl group (an alcoholic hydroxyl group and a phenolic hydroxyl group), an amino group, a carboxyl group, and a mercapto group. Among these, an alcoholic hydroxyl group is preferable. The skeleton of the modified resin is preferably the same as that of the resin soluble in an organic solvent, in consideration of uniformity of the particles. A modified resin having a polyester skeleton is preferable. A method for obtaining a resin having an alcoholic hydroxyl group at a terminal of polyester may be a polycondensation reaction of a polyol and a polycarboxylic acid, in which the number of functional groups of the polyol is greater than the number of functional groups of the polycarboxylic acid.

(Amine Compound)

The isocyanate groups of the modified resin hydrolyze in the process of obtaining particles by dispersing an oil phase in an aqueous phase, and partially change to amino groups, and the produced amino groups react with unreacted isocyanate groups to progress an elongation reaction. In order to securely induce an elongation reaction in addition to the above reaction, or in order to introduce cross-linking points, it is possible to use an amine compound in combination. Examples of the amine compound (B) include diamine (B1), trivalent or higher polyamine (B2), amino alcohol (B3), amino mercaptan (B4), amino acid (B5), and a product (B6) obtained by blocking an amino group of (B1) to (B5).

Examples of the diamine (B1) include: aromatic diamine (e.g., phenylene diamine, diethyl toluene diamine, 4,4′ diaminodiphenylmethane, tetrafluoro-p-xylylene diamine, and tetrafluoro-p-phenylene diamine); alicyclic diamine (e.g., 4,4′-diamino-3,3′ dimethyldicyclohexyl methane, diaminecyclohexane, isophoronediamine); and aliphatic diamine (e.g., ethylene diamine, tetramethylene diamine, hexamethylenediamine, dodecafluorohexylene diamine and tetracosafluorododecylene diamine). Examples of the trivalent or higher polyamine (B2) include diethylenetriamine, and triethylene tetramine.

Examples of the amino alcohol (B3) include ethanol amine, and hydroxyethyle aniline. Examples of the amino mercaptan (B4) include aminoethyl mercaptan, aminopropyl mercaptan. Examples of the amino acid (B5) include aminopropionic acid and aminocaproic acid.

Examples of the product (B6) obtained by blocking an amino group of (B1) to (B5) include a ketimine compound obtained from the amines (B1) to (B5) and ketones (e.g., acetone, methyl ethyl ketone, and methyl isobutyl ketone), and an oxazoline compound. Among these amines (B), (B1), and a mixture between (B1) and a small amount of (B2) are preferable.

As the ratio of the amine (B), the number of amino groups [NHx] in the amine (B) is equal to or less than 4 times, preferably equal to or less than twice, more preferably equal to or less than 1.5 times, and yet more preferably equal to or less than 1.2 times as large as the number of isocyanate groups [NCO] in a prepolymer (A) having the isocyanate groups. When the number of amino groups is greater than 4 times as large, excessive amino groups may block the isocyanate and inhibit the elongation reaction of the modified resin, which may result in a low molecular weight of the polyester and a poor hot offset resistance.

(Organic Solvent)

It is preferable that the organic solvent have a boiling point of lower than 100° C. and be volatile, because this makes subsequent desolventization easy. Examples of such an organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. One of these may be used, or two or more of these may be used in combination. When the resin to be dissolved or dispersed in the organic solvent is a resin having a polyester skeleton, use of an ester-based solvent such as methyl acetate, ethyl acetate, and butyl acetate, or a ketone-based solvent such as methyl ethyl ketone and methyl isobutyl ketone is preferably because the solubility will be high. Among these, methyl acetate, ethyl acetate, and methyl ethyl ketone having a high desolventization property are particularly preferable.

(Aqueous Medium)

An aqueous medium may be water alone, but a solvent miscible with water may be used in combination. Examples of the miscible solvent include: alcohol (e.g., methanol, isopropanol, and ethylene glycol), dimethyl formamide, tetrahydrofuran, cellosolves (e.g., methyl cellosolve (Registered Trademark)), and lower ketones (e.g., acetone, and methyl ethyl ketone).

(Surfactant)

A surfactant is used to disperse an oil phase in the aqueous medium and produce liquid droplets.

Examples of the surfactant include: an anionic surfactant such as alkyl benzene sulfonate salt, α-olefin sulfonate salt, and phosphate ester; a cationic surfactant such as an amine salt type (e.g., alkyl amine salt, amino alcohol fatty acid derivative, polyamine fatty acid derivative, and imidazoline) and a quaternary ammonium salt type (e.g., alkyl trimethyl ammonium salt, dialkyl dimethyl ammonium salt, alkyl dimethyl benzyl ammonium salt, pyridinium salt, alkyl isoquinolinium salt, and benzethonium chloride); a nonionic surfactant such as fatty acid amide derivative and multivalent alcohol derivative; and an amphoteric surfactant such as alanine, dodecyldi(aminoethyl)glycine, di(octylaminoethyl)glycine, and N-alkyl-N,N-dimethyl ammonium betaine. Use of a surfactant having a fluoroalkyl group provides a surface activation effect with a very small amount.

Examples of an anionic surfactant having a fluoroalkyl group that can be used favorably include fluoroalkyl carboxylic acid having 2 to 10 carbon atoms and a metal salt thereof, disodium perfluorooctanesulfonyl glutamate, sodium 3-[ω-fluoroalkyl(C6-C11)oxy]-1-alkyl(C3-C4)sulfonate, sodium 3-[ω-fluoroalkanoyl(C6-C8)-N-ethylamino]-1-propanesulfonate, fluoroalkyl (C11-C20) carboxylic acid and a metal salt thereof, perfluoroalkyl carboxylic acid (C7-C13) and a metal salt thereof, perfluoroalkyl (C4-C12) sulfonic acid and a metal salt thereof, perfluorooctanesulfonic acid diethanol amide, N-propyl-N-(2-hydroxyethyl)perfluorooctanesulfonamide, perfluoroalkyl (C6-C10) sulfonamide propyl trimethyl ammonium salt, perfluoroalkyl (C6-C10)-N-ethylsulfonyl glycine salt, and monoperfluoroalkyl (C6-C16) ethyl phosphate ester. Examples of a cationic surfactant include aliphatic primary, secondary, or tertiary amine acid having a fluoroalkyl group, aliphatic quaternary ammonium salt such as perfluoroalkyl (C6-C10) sulfonamide propyl trimethyl ammonium salt, benzalkonium salt, benzethonium chloride, pyridinium salt, and imidazolinium salt.

(Inorganic Dispersant)

A dissolved or dispersed product of a toner composition may be dispersed in the aqueous medium in the presence of an inorganic dispersant or resin particles. As the inorganic dispersant, tricalcium phosphate, calcium carbonate, titanium oxide, colloidal silica, hydroxyapatite, or the like is used. Use of a dispersant is more preferable because a granularity distribution will be sharp, and dispersion will be stable.

(Protective Colloid)

Dispersion liquid droplets may be stabilized with a polymeric protective colloid.

Usable examples thereof include: acids such as acrylic acid, methacrylic acid, α-cyanoacrylic acid, α-cyanomethacrylic acid, itaconic acid, crotonic acid, fumaric acid, and maleic acid or maleic anhydride; (meth)acrylic-based monomer having a hydroxyl group such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate ester, diethylene glycol monomethacrylate ester, glycerin monoacrylate ester, glycerin monomethacrylate ester, N-methylolacrylamide, and N-methylolacrylamide; vinyl alcohol or ethers with vinyl alcohol, such as vinyl methyl ether, vinyl ethyl ether, and vinyl propyl ether; esters between vinyl alcohol and compounds having a carboxyl group, such as vinyl acetate, vinyl propionate, and vinyl butyrate; acrylamide, methacrylamide, and diacetone acrylamide, or a methylol compound of these; acid chlorides such as acrylic acid chloride, and methacrylic acid chloride; homopolymers or copolymers having a nitrogen atom or a nitrogen atom heterocycle, such as vinyl pyridine, vinyl pyrrolidone, vinyl imidazole, and ethylene imine; polyoxyethylene series such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester, and polyoxyethylene nonyl phenyl ester; and celluloses such as methyl cellulose, hydroxyethyl cellulose, and hydroxypropyl cellulose.

When a dispersion stabilizer that is soluble in an acid or an alkali, such as calcium phosphate salt is used, the calcium phosphate salt is removed from the particles by water washing or the like, after once the calcium phosphate salt is dissolved in an acid such as hydrochloric acid. It can also be removed by such an operation as enzymatic decomposition. When a dispersant is used, the dispersant may be kept remaining over the surface of the toner particles. However, in terms of toner chargeability, it is preferable to wash and remove the dispersant after an elongation reaction, a cross-linking reaction, or both thereof.

(Colorant)

A colorant used in the present invention may be any of publicly-known dyes and pigments. Examples thereof include carbon black, a nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazine lake, quinoline yellow lake, anthrasan yellow BGL, isoindolinone yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and a mixture thereof.

(Colorant Master Batching)

The colorant used in the present invention may be used in the form of a master batch in which it is combined with a resin.

Examples of a binder resin that is kneaded in the production of a master batch or together with a master batch include: the modified or unmodified polyester resin mentioned above; polymer of styrene or substitution thereof (e.g., polystyrene, poly-p-chlorostyrene, and polyvinyl toluene); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl a-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleate ester copolymer); and others including polymethyl methacrylate, polybutyl methacrylate, polyvinyl chloride, polyvinyl acetate, polyethylene, poly-propylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, and paraffin wax. These may be used alone, or as a mixture.

(Master Batch Production Method)

The master batch can be obtained by mixing and kneading a resin for master batch and the colorant under a high shearing force. Here, an organic solvent may be used in order to enhance interactions between the colorant and the resin. It is preferable to use a so-called flashing method of mixing and kneading an aqueous paste of the colorant that contains water, together with the resin an organic solvent, transferring the colorant to the resin, and removing the water component and the organic solvent component, because this method allows a wet cake of the colorant to be used as it is without being dried. It is preferable to use a high shear disperser such as a three-roll mill for mixing and kneading.

(External Additive)

In the present invention, one or more kinds of particles are used as external additives. Primary particles of at least one kind of the one or more kinds of particles have a number average particle diameter of from 0.01 μm to 0.05 μm. Particles having a large particle diameter serve as a spacer for suppressing contact between the toner and the members, and particles having a small particle diameter impart flowability to the toner. External additives having a larger particle diameter loose from the toner more easily, and are promoted to transfer to the photoconductor. External additives serve to impart flowability and chargeability. Particles used as the external additives may be inorganic particles or may be organic particles.

It is preferable that at least one kind of the external additives be charged to a polarity opposite to that of the base particles of the toner. Addition of an external additive having an opposite polarity to that of the base particles of the toner is preferable because such an external additive will be suppressed from adhering to the cleaning blade when an image area is small, without being developed on an image unformed portion.

(Inorganic Particles)

Examples of the inorganic particles used as external additives in the present invention include silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among these, silica and titanium oxide are particularly preferable. Silica is more preferable in terms of adhesion to a member, and hydrophobized silica is particularly preferable. Hydrophobized silica itself is less likely to adhere to the cleaning member, which is preferable because occurrence of image quality degradation can be suppressed.

(Organic Particles)

Examples of the organic particles used as external additives in the present invention include: polymer of styrene or substitution thereof (e.g., polystyrene, poly-p-chlorostyrene, and polyvinyl toluene); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl a-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleate ester copolymer); and others including polymethyl methacrylate, polybutyl methacrylate, polyvinyl chloride, polyvinyl acetate, polyethylene, poly-propylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, and paraffin wax. These may be used alone, or as a mixture.

(Hydrophobization)

It is preferable that the surface of the external additives used in the present invention be hydrophobized. As the method for hydrophobizing, for example, inorganic particles, a method of chemically treating the inorganic particles with an organosilicon compound that is reactive or physically adsorptive with the inorganic particles is used. A preferable method is a method of treating inorganic particles produced from vapor phase oxidation of a metal halide with an organosilicon compound.

Examples of the organosilicon compound used for the hydrophobization include hexamethyl disilazane, trimethyl silane, trimethyl chlorosilane, trimethyl ethoxysilane, dimethyl dichlorosilane, methyl trichlorosilane, allyldimethyl chlorosilane, allylphenyl dichlorosilane, benzyl dimethyl chlorosilane, bromine methyl dimethyl chlorosilane, α-chloroethyl trichlorosilane, p-chloroethyl trichlorosilane, chloromethyl dimethyl chlorosilane, triorganosilyl mercaptan, trimethylsilyl mercaptan, triorganosilyl acrylate, vinyldimethyl acetoxy silane, dimethyl ethoxy silane, dimethyl dimethoxy silane, diphenyl diethoxy silane, hexamethyl disiloxane, 1,3-divinyl tetramethyl disiloxane, 1,3-diphenyl tetramethyl disiloxane, and dimethyl polysiloxane having 2 to 12 siloxane units per molecule, and having a hydroxyl group bonded per Si atom at each of the terminal units.

A nitrogen-containing silane coupling agent can be used for hydrophobization of untreated inorganic particles. A case described here is a case where the base particles of the toner are charged to a negative polarity. It is preferable that any external additive that has a chargeability to the opposite polarity to that of the base particles be particles that are surface-treated with a nitrogen-containing silane coupling agent. Examples of such a treating agent include aminopropyl trimethoxy silane, aminopropyl triethoxy silane, dimethyl aminopropyl trimethoxy silane, diethyl aminopropyl trimethoxy silane, dipropyl aminopropyl trimethoxy silane, dibutyl aminopropyl trimethoxy silane, monobutyl aminopropyl trimethoxy silane, dioctyl aminopropyl trimethoxy silane, dibutyl aminopropyl dimethoxy silane, dibutyl aminopropyl monomethoxy silane, dimethyl aminophenyl triethoxy silane, trimethoxysilyl-γ-propyl phenyl amine, trimethoxysilyl-γ-propyl benzine amine, trimethoxysilyl-γ-propyl piperidine, trimethoxysilyl-γ-propyl morpholine, and trimethoxysilyl-γ-propyl imidazole. These treating agents may be used alone, or as a mixture of two or more kinds.

In the present invention, hydrophobized or unhydrophobized inorganic particles that are treated with a silicone oil may be used. In this case, usable examples of the silicone oil include dimethyl silicone oil, methyl phenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, acrylic or methacrylic-modified silicone oil, and a methyl styrene-modified silicone oil. These silicone oils are used alone, or as a mixture of two or more kinds. In the treatment of inorganic particles with a silicone oil, the inorganic particles that have been dewatered and dried sufficiently beforehand in an oven of several hundred degrees Celsius, and a silicone oil are brought into contact with each other uniformly, to attach the silicone oil to the surface of the inorganic particles. In order to attach the silicone oil, the inorganic particles and the silicone oil may be mixed sufficiently with a mixer such as a rotor blade in a manner to maintain the particles in the powder state, or the silicone oil may be dissolved in a solvent that can dilute the silicone oil and has a relatively low boiling point, and the inorganic particles may be immersed in the liquid and then dried by removing the solvent. When the silicone oil has a high viscosity, the treatment in the liquid is preferable. After this, the inorganic particles to which the silicone oil has been attached may be subjected to a thermal treatment in an oven of from 100° C. to several hundred degrees Celsius (typically, about 400° C.), which enables a siloxane bond between the metal and the silicone oil to be formed with the use of the hydroxyl group on the surface of the inorganic particles, or enables the silicone oil itself to be increased in molecular weight and cross-linked. The reaction may be promoted by previously adding a catalyst such as an acid, an alkali, a metal salt, zinc octylate, tin octylate, and dibutyl tin dilaurate in the silicone oil. By the silicone oil being transferred to the electrostatic latent image bearer, it is possible to suppress the frictional force between the image bearer and the cleaning blade for a long term, and suppress wear significantly.

Inorganic particles used in the present invention may be previously treated with a silane coupling agent as a hydrophobizing agent, before the treatment with the silicone oil. Inorganic particles previously hydrophobized can adsorb more silicone oil.

(Content of External Additives)

The total amount of external additives to be added is preferably a content of from 4.0 parts by mass to 7.0 parts by mass, and more preferably from 4.0 parts by mass to 5.5 parts by mass relative to 100 parts by mass of the base particles in the toner. When the content is less than 4.0 parts by mass, formation of a toner accumulation layer will be insufficient, which is unfavorable. When the content is greater than 7.0 parts by mass, the amount of external additives to loose will be excessive, which is unfavorable because troubles such as contamination of the members are more likely to occur, and low temperature fixability will be degraded.

Further, a content of an external additive of which primary particles have a number average particle diameter of from 0.01 μm to 0.05 μm is preferably from 1.0 part by mass to 2.5 parts by mass relative to 100 parts by mass of the base particles of the toner. External additives having smaller particle diameters have a greater attaching strength, and contribute to stabilization of toner chargeability.

When two or more kinds of external additives are used in combination, the range of the content values described above may be the total of these two or more kinds of external additives.

(Quantification of External Additives)

For quantification of the external additives of the toner, 2 g of the toner for measurement is picked, to which a force of 1 N/cm² is applied for 60 seconds, to produce a circular toner pellet. The obtained pellet is measured with a wavelength-dispersive X-ray fluorescence analyzer XRF1700 manufactured by Shimadzu Corporation, to quantify the elements (e.g., Si, and Ti) unique to the external additives used on the toner, and calculate the composition amounts of the external additives present in the toner (e.g., the amounts of metal oxide particles: a SiO₂ amount and a TiO₂ amount) in the unit of % by mass according to a calibration curve method.

<Equipment>
A wavelength-dispersive X-ray fluorescence analyzer ZRF1700 manufactured by Shimadzu Corporation for X-ray fluorescence analysis

<Pellet Production>
2 g of the toner is picked, to which a force of 1 N/cm² (10 MPa) is applied with a pressing machine for 60 seconds, to produce a circular toner pellet.

<Quantification>
With an X-ray fluorescence analyzer, quantification is performed based on the elements unique to the external additives of the toner (e.g., silicon when an external additive is silica) according to a calibration curve method, to calculate the composition amounts of the external additives (% by mass).

(Average Particle Diameter of Primary Particles of External Additives)

An average particle diameter of primary particles of at least one kind of the particles used as the external additives in the present invention is from 0.05 μm to 0.30 μm, and preferably from 0.08 μm to 0.15 μm.

When the average particle diameter is less than 0.05 μm, the external additive is likely to be buried in the base particles of the toner and cannot be counted on for a long-term transferring to the photoconductor, which is insufficient for formation of a firm accumulation layer.

On the other hand, when the average particle diameter is greater than 0.30 μm, the flowability of the toner will be extremely poor, which is unfavorable because the toner cannot function as a toner. Further, it is extremely easy for the external additive to be detached from the base particles, which is unfavorable because the external additive will damage the surface of the photoconductor, etc. unevenly.

Two or more kinds of external additives may be used. It is preferable to select an external additive with a small particle diameter in terms of the flowability of the toner. An average particle diameter of primary particles of an external additive having a small particle diameter is preferably from 0.01 μm to 0.05 μm, and more preferably from 0.01 μm to 0.02 μm. When the average particle diameter is less than 0.01 μm, the external additive will be heavily buried in the base particles of the toner, which is unfavorable because a desired flowability cannot be obtained. When the average particle diameter is greater than 0.02 μm, a desired flowability cannot be obtained likewise, which is unfavorable. Here, the average particle diameter is a number average particle diameter of primary particles.

The average particle diameter of an external additive used in the present invention can be measured with a particle diameter distribution measuring instrument utilizing dynamic light scattering, such as DLS-700 manufactured by Otsuka Electronics Co., Ltd., and COULTER N4 manufactured by Coulter Electronics Inc. However, because it is difficult to disaggregate agglomerated external additive particles, it is preferable to directly measure the particle diameter of the external additive from a toner image obtained with a scanning electron microscope or a transmission electron microscope. In this case, at least 100 or more external additive particles are observed, and an average of their longer diameters is calculated. When the external additive is agglomerated on the surface of the toner, the longer diameter of an individual primary particle is measured likewise.

(Treating Method)

An external additive of the present invention is used by being added and mixed with the toner. A common powder mixer is used for mixing the external additive. A mixer equipped with a jacket or the like and capable of adjusting the internal temperature is preferable. In order to change the history of the load to be applied to the external additive, it is possible to additionally add the external additive halfway or as needed. Needless to say, it is also possible to change the rotation speed, rolling speed, time, temperature, etc. of the mixer. It is possible to apply a strong load first and then a relatively weak load next, or vice versa. Examples of a usable mixing equipment include a rocking mixer, a lodige mixer, a nauta mixer, and a Henschel mixer.

(Release Agent)

A release agent may be added in the toner for improving releasability in fixing. For example, it is possible to contain a release agent in the toner by dispersing the release agent in the organic solvent in which toner materials are dispersed during the production process.

As the release agent, one that has a sufficiently low viscosity when heated during a fixing process, and is less likely to be compatibilized with any other material on the surface of the fixing member, or is less likely to swell, such as a wax and a silicone oil is used. It is preferable to use a wax that is present in a solid state inside during a normal storage, in view of the storage stability of the release agent.

Specific examples of the wax include long-chain hydrocarbon, and a carbonyl group-containing wax. Examples of the long-chain hydrocarbon include: polyolefin wax (e.g., polyethylene wax, and poly-propylene wax); petroleum-based wax (e.g., paraffin wax, Sasol wax, microcrystalline wax); and Fischer-Tropsch wax.

Examples of the carbonyl-group containing wax include polyalkanoate ester (e.g., carnauba wax, montan wax, trimethylolpropane tribehenate, pentaerythritol tetrabehenate, pentaerythritol diacetate dibehenate, glycerin tribehenate, and 1,18-octadecanediol distearate); polyalkanol ester (e.g., tristearyl trimellitate, and distearyl maleate); polyalkanoic acid amide (e.g., ethylene diamine dibehenyl amide); polyalkyl amide (e.g., trimellitic acid tristearyl amide); and dialkyl ketone (e.g., distearyl ketone).

Among these, a long-chain hydrocarbon which has a particularly good releasability is preferable. Further, when a long-chain hydrocarbon is used as the release agent, a carbonyl group-containing wax may be used in combination. The content of the release agent in the toner is from 2% by mass to 25% by mass, preferably from 3% by mass to 20% by mass, and more preferably from 4% by mass to 15% by mass. When the content is less than 2% by mass, the release agent cannot exert the effect of improving releasability in fixing. When the content is greater than 25% by mass, the mechanical strength of the toner will be degraded.

(Charge Controlling Agent)

As needed, a charge controlling agent may be dissolved or dispersed in the organic solvent. As the charge controlling agent, any publicly-known charge controlling agents may be used. Examples thereof include nigrosine-based dye, triphenylmethane-based dye, chromium-containing metal complex dye, molybdenum acid chelate pigment, rhodamine-based dye, alkoxy-based amine, quaternary ammonium salt (including fluorine-modified quaternary ammonium salt), alkyl amide, phosphorus or phosphorus compound, tungsten or tungsten compound, fluorine-based active agent, salicylic acid metal salt, and salicylic acid derivative metal salt. Specific examples include: nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (both manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (all manufactured by Hoechst AG); LRA-901, and boron complex LR-147 (manufactured by Japan Carlit Co., Ltd.); copper phthalocyanine; perylene; quinacridone; azo-pigments; and polymeric compounds having, as a functional group, a sulfonic acid group, carboxyl group, and quaternary ammonium salt. The charge controlling agent may be used in an amount in a range in which it expresses its capability and does not inhibit fixability, and the content of the charge controlling agent in the toner is from 0.5% by mass to 5% by mass, and preferably from 0.8% by mass to 3% by mass.

(Toner Production Method)

A toner production method is not particularly limited, and examples thereof include publicly-known wet granulation methods such as a dissolution suspension method, a suspension polymerization method, and an emulsification aggregation method, and a pulverization method. A dissolution suspension method, a suspension polymerization method, and an emulsification aggregation method are preferable because it is easy to control a particle diameter and a shape.

When an emulsification method or a suspension polymerization method is used to obtain toner base particles to be the core, in a step after the toner base particles to be the core are obtained according to each publicly-known method, resin particles are added to the system to be attached and fused with the surface of the toner base particles to be the core. In order to promote attachment and fusing, heating may be performed. It is also effective to add a metal salt for promoting attachment and fusing.

(Resin Particles)

Resin particles to form protrusions in the present invention may be resin particles dispersed in an aqueous medium. Examples of the resin to constitute the resin particles include a vinyl-based resin, polyester, polyurethane, polyurea, and epoxy resin. Among these, a vinyl-based resin is preferable because resin particles dispersed in an aqueous medium can be easily obtained. Examples of the method for obtaining an aqueous medium dispersion of vinyl-based resin particles include publicly-known polymerization methods such as an emulsification aggregation method, a suspension polymerization method and a dispersion polymerization method. Among these, an emulsion polymerization method according to which particles having a particle diameter suitable for the present invention can be easily obtained is particularly preferable.

(Vinyl-Based Resin Particles)

The vinyl-based resin particles used in the present invention contain a vinyl-based resin obtained by polymerizing a monomer mixture containing at least a styrene-based monomer.

To be used as a toner, the base particles should have an electrically chargeable structure on the surface thereof. For this purpose, the styrene-based monomer that has electron orbitals on which electrons can exist stably as in an aromatic ring structure is used in the monomer mixture in an amount of from 50% by mass to 100% by mass, preferably from 80% by mass to 100% by mass, and more preferably from 95% by mass to 100% by mass. When the styrene-based monomer is less than 50% by mass, the toner to be obtained will have a poor chargeability and is limited in applications.

Here, a styrene-based monomer refers to an aromatic compound having a vinyl polymerizable functional group. Examples of polymerizable functional groups include vinyl group, isopropenyl group, aryl group, acryloyl group, and methacryloyl group.

Specific examples of the styrene-based monomer include styrene, a methyl styrene, 4-methyl styrene, 4-ethyl styrene, 4-tert-butyl styrene, 4-methoxy styrene, 4-ethoxy styrene, 4-carboxy styrene or a metal salt thereof, 4-styrene sulfonic acid or a metal salt thereof, 1-vinyl naphthalene, 2-vinyl naphthalene, allyl benzene, phenoxy alkylene glycol acrylate, phenoxy alkylene glycol methacrylate, phenoxy polyalkylene glycol acrylate, and phenoxy polyalkylene glycol methacrylate. Among these, it is preferable to mainly use styrene that is easily available, and has an excellent reactivity and a high chargeability.

The vinyl-based resin used in the present invention contains an acid monomer in an amount of from 0% by mass to 7% by mass, and more preferably in an amount of from 0% by mass to 4% by mass in the monomer mixture, and yet more preferably is free of an acid monomer. When an acid monomer is contained in an amount greater than 7% by mass, the vinyl-based resin particles to be obtained will have a high dispersion stability themselves. Therefore, when the vinyl-based resin particles are added in a dispersion liquid in which oil droplets are dispersed in an aqueous phase, they do not easily attach to the oil droplets at normal temperature, or even if they attach, they are in a state about to be detached, and will be easily detached in a process of desolventization, washing, drying, and external addition. When an acid monomer is contained in an amount of 4% by mass or less, chargeability variation depending on the conditions of use of the toner to be obtained can be suppressed.

Here, an acid monomer refers to a compound having a vinyl polymerizable functional group and an acid group. Examples of the acid group include: carboxyl acid, sulfonyl acid, and phosphonyl acid.

Examples of the acid monomer include carboxyl group-containing vinyl-based monomer and a salt thereof (e.g., (meth)acrylic acid, maleic acid (and anhydride thereof), monoalkyl maleate, fumaric acid, monoalkyl fumarate, crotonic acid, itaconic acid, monoalkyl itaconate, glycol monoether itaconate, citraconic acid, monoalkyl citraconate, and cinnamic acid); sulfonic acid group-containing vinyl-based monomer; vinyl-based sulfate monoester and a salt thereof; and phosphoric acid group-containing vinyl-based monomer and a salt thereof. Among these, (meth)acrylic acid, maleic acid (and anhydride thereof), monoalkyl maleate, fumaric acid, and monoalkyl fumarate are preferable.

Meanwhile, in order to control compatibility with the core particles, a content of a monomer having an ethylene oxide (EO) chain, such as phenoxy alkylene glycol acrylate, phenoxy alkylene glycol methacrylate, phenoxy polyalkylene glycol acrylate, and phenoxy polyalkylene glycol methacrylate is equal to or less than 10% by mass, preferably equal to or less than 5% by mass, and yet more preferably equal to or less than 2% by mass of the whole monomer. When the content of such a monomer is greater than 10% by mass, an amount of polar groups on the surface of the toner will be high to significantly degrade environmental stability of the chargeability, which is unfavorable. Further, compatibility with the core particles will be so high that the coverage by the protrusions will be small, which reduces a surface reforming effect, which is unfavorable. To control compatibility with the core particles, a monomer having an ester bond such as 2-acryloyloxy ethyl succinate, and 2-methacryloyloxy ethyl phthalic acid may also be used in combination. The content of such a monomer is equal to or less than 10% by mass, preferably equal to or less than 5% by mass, and more preferably equal to or less than 2% by mass of the whole monomer. When the content of such a monomer is greater than 10% by mass, an amount of polar groups on the surface of the toner will be high to significantly degrade environmental stability of the chargeability, which is unfavorable. Further, compatibility with the core particles will be so high that the coverage by the protrusions will be small, which reduces a surface reforming effect, which is unfavorable.

A method for obtaining the vinyl-based resin particles is not particularly limited, and the following methods (a) to (f) can be raised as examples.

(a) The monomer mixture is reacted through a polymerization reaction according to a suspension polymerization method, an emulsion polymerization method, a seed polymerization method, a dispersion polymerization method or the like, to thereby produce a dispersion liquid of the vinyl-based resin particles.

(b) The monomer mixture is polymerized beforehand, and the obtained resin is pulverized with a mechanical rotational or jet-type micro pulverizer, and then classified, to thereby produce resin particles.

(c) The monomer mixture is polymerized beforehand, and a resin solution obtained by dissolving the obtained resin in a solvent is sprayed in a mist form, to thereby produce resin particles.

(d) The monomer mixture is polymerized beforehand, a solvent is added to a resin solution obtained by dissolving the obtained resin in a solvent, or a resin solution obtained by thermally dissolving the obtained resin in a solvent is cooled, to deposit resin particles, and then the solvent is removed, to thereby produce resin particles.

(e) The monomer mixture is polymerized beforehand, an appropriate emulsifier is dissolved in a resin solution obtained by dissolving the obtained resin in a solvent, and water is added to the resultant, to thereby make the resultant undergo a phase-transfer emulsification.

Among these, the method (a) is preferable because the method can produce resin particles easily and can smooth the application of the resin particles to the succeeding step because the resin particles can be obtained in the form of a dispersion liquid.

For the purpose of the polymerization reaction in the method (a), it is preferable to take a measure of adding a dispersion stabilizer in an aqueous medium, or a measure of adding a monomer (a so-called reactive emulsifier) that can impart dispersion stability to the resin particles to be produced from the polymerization to the monomer that is to undergo the polymerization reaction, or both, to thereby impart dispersion stability to the vinyl-based resin particles to be produced. Without a dispersion stabilizer or a reactive emulsifier, the vinyl-based resin may not be obtained in the form of particles because the particle-dispersed state cannot be maintained, or the obtained resin particles may have a low dispersion stability and hence a low storage stability to thereby aggregate during storage, or the dispersion stability of the particles may be poor in a resin particle attaching step described below, to make it likely for the core particles to aggregate and coalesce, and make the toner base particles, which are to be obtained finally, to be less uniform in the particle diameter, shape, and surface, which is unfavorable.

Examples of the dispersion stabilizer include a surfactant and an inorganic dispersant. Examples of the surfactant include: an anionic surfactant such as alkyl benzene sulfonate salt, α-olefin sulfonate salt, and phosphate ester; a cationic surfactant such as an amine salt type (e.g., alkyl amine salt, amino alcohol fatty acid derivative, polyamine fatty acid derivative, and imidazoline) and a quaternary ammonium salt type (e.g., alkyl trimethyl ammonium salt, dialkyl dimethyl ammonium salt, alkyl dimethyl benzyl ammonium salt, pyridinium salt, alkyl isoquinolinium salt, and benzethonium chloride); a nonionic surfactant such as fatty acid amide derivative and multivalent alcohol derivative; and an amphoteric surfactant such as alanine, dodecyldi(aminoethyl)glycine, di(octylaminoethyl)glycine, and N-alkyl-N,N-dimethyl ammonium betaine. Examples of the inorganic dispersant include tricalcium phosphate, calcium carbonate, titanium oxide, colloidal silica, and hydroxyapatite.

A weight average molecular weight of the vinyl-based resin is from 3,000 to 300,000, preferably from 4,000 to 100,000, and more preferably from 5,000 to 50,000. When the weight-average molecular weight is less than 3,000, the vinyl-based resin will have a weak mechanistic strength and be brittle, which makes it likely for the surface of the toner base particles, which are to be obtained finally, to easily change depending on the conditions of use according to the application of the toner base particles, which may cause troubles such as severe variation of chargeability, contamination such as adhesion to surrounding members, and accompanying troubles in quality, which is unfavorable. When the weight average molecular weight is greater than 300,000, the vinyl-based resin will have less molecular terminals, less entwining with the core particles via molecular chains, and less attachability to the core particles, which is unfavorable.

A glass transition temperature (Tg) of the vinyl-based resin is from 45° C. to 100° C., preferably from 55° C. to 90° C., and more preferably from 65° C. to 80° C. When stored under high-temperature, high-humidity conditions, the resin in the protrusions may be plasticized by the water content in the air, and the glass transition temperature of the resin may be lowered. A glass transition temperature lower than 45° C. is not preferable, because under high-temperature, high-humidity conditions of 40° C. and 90% assumed during shipping of the toner or a toner cartridge, the obtained toner base particles may deform under a certain pressure, or the toner base particles may fuse with each other, which may deprive the toner of its original behavior as particles. Further, when the vinyl-based resin is used for one-component development, a glass transition temperature lower than 45° C. is not preferable, because the durability of the vinyl-based resin against friction will be poor. A glass transition temperature higher than 100° C. is not preferable, because fixability will be degraded.

(Oil Phase Producing Step)

As a method for producing an oil phase in which a resin, a colorant, etc. are dissolved or dispersed in an organic solvent, it is possible to add the resin, the colorant, etc. in the organic solvent gradually while stirring the organic solvent, for them to be dissolved or dispersed. When a pigment is used as the colorant, or when any of a release agent, a charge controlling agent, etc. to be added is sparingly soluble in the organic solvent, it is preferable to make their particles small before addition to the organic solvent.

Colorant master batching described above can also be a means to take, and the same method may be applied to the release agent and the charge controlling agent.

As another means, it is possible to add a dispersion aid as needed in the organic solvent, and disperse the colorant, the release agent, and the charge controlling agent in a wet manner, to thereby obtain a wet master.

As yet another means, when the substances to be dispersed melt below the boiling point of the organic solvent, it is possible to add a dispersion aid as needed in the organic solvent, stir the organic solvent with the dispersoids while heating them to once dissolve them, and then cool them while stiffing or shearing them to crystallize them, to thereby produce microcrystals of the dispersoids.

The colorant, the release agent, and the charge controlling agent dispersed by any of the above means may further be dispersed after dissolved or dispersed together with the resin in the organic solvent. For the dispersion, a publicly-known disperser such as a bead bill, and a disk mill may be used.

(Toner Base Particle Producing Step)

A method for dispersing the oil phase obtained in the step described above in an aqueous medium containing at least a surfactant to thereby produce a dispersion liquid in which toner base particles made of the oil phase are dispersed is not particularly limited, and publicly-known equipment such as a low speed shearing system, a high speed shearing system, a frictional system, a high pressure jetting system, and an ultrasonic system may be used. A high speed shearing system is preferable to make the dispersion elements have a particle diameter of from 2 μm to 20 μm. When a high speed shearing disperser is used, the rotation speed is not particularly limited, but is typically from 1,000 rpm to 30,000 rpm, and preferably from 5,000 rpm to 20,000 rpm. The dispersion time is not particularly limited, but is typically from 0.1 minutes to 5 minutes in the case of a batch system. When dispersion is performed longer than a dispersion time of 5 minutes, particles having an undesirable small diameter may remain, or the dispersion may result in an excessively dispersed state to make the system unstable and produce aggregates or coarse particles, which is unfavorable. The temperature during the dispersion is typically from 0° C. to 40° C., and preferably from 10° C. to 30° C. When the temperature during the dispersion becomes higher than 40° C., the molecular motion becomes active to lower the dispersion stability and make it likely to produce aggregates and coarse particles, which is unfavorable. When the temperature during the dispersion becomes lower than 0° C., the viscosity of the dispersion elements becomes high, which increases the shearing energy required for the dispersion and reduces the production efficiency. As the surfactant, those that are mentioned in the above description of the method for producing the resin particles may be used. However, in order to disperse oil droplets containing a solvent efficiently, a disulfonate salt-based surfactant having a relatively high HLB is preferable. The concentration of the surfactant in the aqueous medium is from 1% by mass to 10% by mass, preferably from 2% by mass to 8% by mass, and more preferably from 3% by mass to 7% by mass. When the concentration of the surfactant is higher than 10% by mass, the surfactant may make the oil droplets too small, or form an inverted micelle structure to reduce dispersion stability conversely and make the oil droplets coarse, which is unfavorable. When the concentration of the surfactant is lower than 1% by mass, the surfactant may not be able to disperse the oil droplets stably to make the oil droplets coarse, which is unfavorable.

(Resin Particle Attaching Step)

When a dissolution suspension method is employed, it may be based on the method described above. However, it is more preferable to add the resin particles and attach and fuse the resin particles to the surface of oil phase liquid droplets, in a state that the oil phase obtained by dissolving or dispersing the constituent materials of the toner base particles to be the core in the organic solvent is dispersed in the aqueous medium, because the toner base particles to be the core and the resin particles can attach and fuse with each other firmly. It is not preferable to add the resin particles in the toner core particle producing step, because the protrusions may become coarse and uneven.

The obtained toner base particle dispersion liquid can maintain the liquid droplets of the core particles stable as long as it is stirred. The dispersion liquid of the resin particles described above is poured in the toner base particle dispersion liquid in this state, to attach the resin particles to the toner base particles. It is preferable to pour the dispersion liquid of the vinyl-based resin particles by taking 30 seconds or longer. When it is poured in less than 30 seconds, the dispersion system may change abruptly, to make the particles aggregate or make the vinyl-based resin particles attach unevenly. On the other hand, it is not preferable to add the dispersion liquid of the resin particles by taking an immoderately long time, for example, 60 minutes, in terms of production efficiency.

The dispersion liquid of the vinyl-based resin particles may be diluted or condensed for appropriate concentration adjustment, before poured into the core particle dispersion liquid. The concentration of the dispersion liquid of the vinyl-based resin particles is preferably from 5% by mass to 30% by mass, and more preferably from 8% by mass to 20% by mass. When the concentration of the dispersion liquid of the vinyl-based resin particles is less than 5% by mass, the concentration of the organic solvent will change greatly upon pouring of the dispersion liquid, which may result in insufficient attachment of the resin particles, which is unfavorable. When the concentration of the dispersion liquid of the vinyl-based resin particles is greater than 30% by mass, the resin particles tend to be distributed unevenly in the core particle dispersion liquid and attached unevenly as a result, which must be avoided.

The mass of the surfactant for production of the oil phase liquid droplets is equal to or less than 7%, preferably equal to or less than 6%, and more preferably equal to or less than 5% of the mass of the whole aqueous phase. When the mass of the surfactant is greater than 7% of the mass of the whole aqueous phase, uniformity of the longer-direction length of the protrusions will be significantly low, which is unfavorable.

It is considered that the reasons for which the method of the present invention can make the vinyl-based resin particles attach to the core particles with a sufficient strength are that when the vinyl-based resin particles attach to the core particle liquid droplets, the core particles can deform freely to thereby form a sufficient surface of contact with the interface to the vinyl-based resin particles, and that the vinyl-based resin particles are swelled or dissolved by the organic solvent, to form conditions under which the vinyl-based resin particles and the resins in the core particles can contact with each other easily. Hence, in this state, it is necessary that the organic solvent be present in the system sufficiently. Specifically, the organic solvent is in an amount of from 50% by mass to 150% by mass, and preferably from 70% by mass to 125% by mass relative to the solid component (e.g., the resins, the colorant, and as needed, the release agent, the charge controlling agent, etc.). When the amount of the organic solvent is greater than 150% by mass relative to the solid component, the amount of toner base particles obtained per producing step is low with a poor production efficiency, and the organic solvent in the high amount reduces the dispersion stability to make stable production impossible, which is unfavorable.

The temperature when attaching the vinyl-based resin particles to the core particles is from 10° C. to 60° C., and preferably from 20° C. to

45° C. When the temperature becomes higher than 60° C., the energy required for the production is increased to thereby increase environmental impacts in the production, and the dispersion becomes unstable due also to the presence of the vinyl-based resin particles having a low acid value on the surface of the liquid droplets, which may produce coarse particles, which is unfavorable. On the other hand, when the temperature becomes lower than 10° C., the viscosity of the dispersion elements becomes high, which makes attachment of the resin particles insufficient, which is unfavorable.

The ratio of the mass of the constituent resins of the resin particles to the whole mass of the toner is from 1% to 20%, preferably from 3% to 15%, and more preferably from 5% to 10%. When the ratio is less than 1%, the effect of the resin particles will be insufficient. When the ratio is greater than 20%, the excessive resin particles attach to the toner core particles weakly, which may be the case of filming, etc.

In addition to the method described above, there is a method of mixing and stirring the toner base particles and the resin particles to mechanically attach the resin particles and make them cover the toner base particles.

(Desolventizing Step)

To remove the organic solvent from the obtained toner base particle dispersion, it is possible to employ a method of gradually raising the temperature while stiffing the whole system, to completely vaporize and remove the organic solvent in the liquid droplets.

Alternatively, it is possible to spray the obtained toner base particle dispersion to a dry atmosphere while stiffing the dispersion, to completely remove the organic solvent in the liquid droplets. Alternatively, it is also possible to reduce the pressure while stiffing the toner base particle dispersion, to vaporize and remove the organic solvent. The latter two methods may be employed in combination with the first method. Common examples of the dry atmosphere to which the emulsified dispersion is sprayed include gases such as air, nitrogen, carbon dioxide gas, and combustion gas that are heated, and particularly, various gas streams heated to a temperature equal to or higher than the boiling point of the solvent having the highest boiling point among the solvents used. The intended quality can be obtained sufficiently through a short-time process with a spray dryer, a belt dryer, a rotary kiln, etc.

(Aging Step)

When the modified resin having an isocyanate group at a terminal is added, an ageing step may be performed in order to promote elongation/cross-linking reactions of the isocyanate. The aging time is typically from 10 minutes to 40 hours, and preferably from 2 hours to 24 hours. The reaction temperature is typically from 0° C. to 65° C., and preferably from 35° C. to 50° C.

(Washing Step)

The toner base particle dispersion liquid obtained according to the method described above contains sub materials such as the surfactant, and the dispersant, in addition to the toner base particles. Therefore, the dispersion liquid is washed in order to extract only the toner base particles from among them. Examples of the method for washing the toner base particles include centrifugal separation, reduced pressure filtration, filter press, etc. However, the method is not particularly limited in the present invention. According to any method, a caked body of the toner base particles can be obtained. However, when the toner base particles cannot be washed sufficiently by one operation, the obtained cake may be dispersed in an aqueous medium again to be slurried, and repeatedly subjected to the toner base particle extraction step according to any of the above methods. When washing is by reduced pressure filtration or filter press, an aqueous medium may be made to penetrate the cake to wash away the sub materials involved in the toner base particles. The aqueous medium used for the washing is water, or a mixture solvent obtained by mixing alcohol such as methanol and ethanol in water. However, water is preferable in view of costs and environmental impacts due to waste water disposal, etc.

(Drying Step)

The washed toner base particles contain the aqueous medium in a large amount. Therefore, drying is performed to remove the aqueous medium, which makes it possible to obtain the toner base particles alone. Usable examples of the drying method include methods using dryers such as a spray dryer, a vacuum freeze dryer, a reduced pressure dryer, a static bed dryer, a movable bed dryer, a fluid bed dryer, a rotary dryer, and a stirring dyer. It is preferable to perform drying until finally the dried toner base particles contain a water content in an amount of less than 1%. The toner base particles after dried form soft aggregates. If this is inconvenient in use, the soft aggregates may be pulverized with an apparatus such as a jet mill, a Henschel mixer, a super mixer, a coffee mill, an Oster blender, and a food processor, to thereby loosen the soft aggregates.

(Toner Particle Diameter)

In order for the toner of the present invention to be electrically charged uniformly and sufficiently, a volume average particle diameter of the toner is from 3 μm to 9 μm, preferably from 4 μm to 8 μm, and more preferably from 4 μm to 7 μm. When the volume average particle diameter of the toner is less than 3 μm, the adhesion force of the toner will be higher relative to the volume, which degrades the controllability of the toner by an electric field, which is unfavorable. When the volume average particle diameter of the toner is greater than 9 μm, image qualities such as fine line reproducibility will be poor.

A ratio between the volume average particle diameter and number average particle diameter of the toner (volume average particle diameter/number average particle diameter) is preferably 1.25 or less, more preferably 1.20 or less, and yet more preferably 1.17 or less. When the ratio is greater than 1.25, uniformity of the particle diameter of the toner is poor, the size of the protrusions tends to be varied. Further, through repetition, toner particles with larger particle diameters, or as the case may be, toner particles with smaller particle diameters are consumed, to change the average particle diameter of the toner remaining in the developing device, which makes the optimum developing conditions for developing residual toner mismatched, and makes it more likely to cause phenomena such as a charging failure, radical increase or decrease in the amount of toner conveyed, toner clogging, and toner spilling

Examples of an instrument for measuring a granularity distribution of the toner particles include COULTER COUNTER TA-II and COULTER MULTISIZER (both manufactured by Coulter Inc.). The measuring method will be described below.

First, a surfactant (preferably, alkyl benzene sulfonate salt) (from 0.1 ml to 5 ml) is added as a dispersant in an electrolytic aqueous solution (from 100 ml to 150 ml). Here, an electrolytic solution refers to an about 1% NaCl aqueous solution prepared with primary sodium chloride, and may be, for example, ISOTON-II (manufactured by Coulter Inc.). Then, a measurement sample (from 2 mg to 20 mg) is added thereto. The electrolytic solution in which the sample is suspended is dispersed with an ultrasonic disperser for about 1 minute to 3 minutes. Then, with the measuring instrument mentioned above, and with an aperture of 100 μm, the toner particles, or the volume and number of the toner are measured, to calculate a volume distribution and a number distribution. A volume average particle diameter (D4) and a number average particle diameter (D1) of the toner can be calculated from the obtained distributions. Channels to be used are thirteen channels, namely a channel of 2.00 μm or greater but less than 2.52 μm, a channel of 2.52 μm or greater but less than 3.17 μm, a channel of 3.17 μm or greater but less than 4.00 μm, a channel of 4.00 μm or greater but less than 5.04 μm, a channel of 5.04 μm or greater but less than 6.35 μm, a channel of 6.35 μm or greater but less than 8.00 μm, a channel of 8.00 μm or greater but less than 10.08 μm, a channel of 10.08 μm or greater but less than 12.70 μm, a channel of 12.70 μm or greater but less than 16.00 μm, a channel of 16.00 μm or greater but less than 20.20 μm, a channel of 20.20 μm or greater but less than 25.40 μm, a channel of 25.40 μm or greater but less than 32.00 μm, and a channel of 32.00 μm or greater but less than 40.30 μm. Target particles are particles having a particle diameter of 2.00 μm or greater but less than 40.30 μm.

(Toner Shape)

An average circularity of the toner is 0.930 or greater, preferably 0.950 or greater, and yet more preferably 0.970 or greater. When the average circularity is less than 0.930, the external additives will be accumulated in the dented portion, and cannot supply the silicone oil easily, which is unfavorable. Further, the toner will have a poor flowability, and hence will cause troubles during development and cannot be transferred efficiently, which is unfavorable.

The average circularity of the toner is measured with a flow-type particle image analyzer FPIA-2000. As a specific measuring method, a surfactant, preferably alkyl benzene sulfonate salt (from 0.1 ml to 0.5 ml) is added as a dispersant to water (from 100 ml to 150 ml) in a container from which impurity solids are removed beforehand, and a measurement sample (from about 0.1 g to 0.5 g) is further added thereto. The suspension liquid in which the sample is dispersed is dispersed with an ultrasonic disperser for about 1 minute to 3 minutes until the concentration of the dispersion liquid becomes from 3,000 particles/μl to 10,000 particles/μl. Then, the shape and distribution of the toner are measured with the instrument mentioned above, to thereby obtain the average circularity.

When the toner is produced by a wet granulation method, ionic toner constituent materials are unevenly distributed near the surface, and as a result, the surface layer of the toner has a relatively low resistance. Hence, the charging speed of the toner is high, and a charge rising property is improved. However, there is a problem that a charge retention property is poor, and the charge buildup amount of the toner tends to decrease rapidly. In order to solve this problem, there is a method of making the toner support a surface treating agent on the surface thereof.

(Measurement of Particle Diameter of Vinyl-Based Resin Particles)

The particle diameter of the resin particles is measured with UPA-150EX (manufactured by Nikkiso Co., Ltd.).

The particle diameter of the resin particles is from 50 nm to 200 nm, preferably from 80 nm to 160 nm, and more preferably from 100 nm to 140 nm. When the particle diameter is less than 50 nm, it is difficult for the resin particles to form sufficiently large protrusions on the surface of the toner. When the particle diameter is greater than 200 nm, the protrusions are likely to become non-uniform, which is unfavorable. A ratio between a volume average particle diameter and a number average particle diameter (volume average particle diameter/number average particle diameter) is preferably 1.25 or less, more preferably 1.20 or less, and yet more preferably 1.17 or less. When the ratio is greater than 1.25, uniformity of the particle diameter of the resin particles is low, and the size of the protrusions is likely to be varied.

(Molecular Weight Measurement (GPC))

The molecular weight of a resin is measured according to GPC (Gel Permeation Chromatography) under the conditions described below.

Instrument: GPC-150C (manufactured by Waters Corporation)

Column: KF801-807 (manufactured by Showa Denko K.K.)

Temperature: 40° C.

Solvent: THF (tetrahydrofuran)

Flow rate: 1.0 mL/minute

Sample: a sample having a concentration of from 0.05% to 0.6% in an injection amount of 0.1 mL

From a molecular weight distribution of the resin measured under the conditions described above, a number average molecular weight and a weight average molecular weight of the resin are calculated with a molecular weight calibration curve generated based on monodisperse polystyrene standard samples. As the standard polystyrene samples for calibration curve generation, SHOWDEX STANDARD STD. NOS. S-7300, S-210, S-390, S-875, S-1980, S-10.9, S-629, S-3.0, and S-0.580, and toluene are used. As a detector, a RI (refractive index) detector is used.

(Measurement (DSC) of Glass Transition Temperature (Tg))

As an instrument for measuring Tg, TG-DSC SYSTEM TAS-100 manufactured by Rigaku Corporation is used.

First, a sample (about 10 mg) is put in an aluminium-made sample container, which is mounted on a holder unit, which is set in an electric furnace. The sample is subjected to DSC measurement by being heated from room temperature to 150° C. at a temperature raising rate of 10° C./min, then left for 10 minutes at 150° C., cooled to room temperature and left for 10 minutes, and again heated to 150° C. under a nitrogen atmosphere at a temperature raising rate of 10° C./min. With an analytical system in the TAS-100 system, Tg is calculated from a contact point at which a tangent line on an endothermic curve and a baseline contact each other near Tg.

(Solid Component Concentration Measurement)

A solid component concentration of the oil phase is measured in the manner described below.

The oil phase (about 2 g) is put within 30 seconds on an aluminium dish of which mass is weighed accurately beforehand (about 1 to 3 g), and the mass of the put oil phase is weighed accurately. This is put in an oven of 150° C. for 1 hour to evaporate the solvent, taken out from the oven, and left and cooled. The total mass of the aluminium dish and the oil phase solid component is measured with an electronic scale. The mass of the aluminium dish is subtracted from the total mass of the aluminium dish and the oil phase solid component to calculate the mass of the oil phase solid component, and the mass of the oil phase component is divided by the mass of the put oil phase to calculate the solid component concentration of the oil phase. The ratio of the amount of the solvent to the solid components in the oil phase is a value obtained by dividing by the mass of the oil phase solid component, a value obtained by subtracting the mass of the oil phase solid component from the mass of the oil phase (i.e., the mass of the solvent).

(Acid Value Measurement)

An acid value of a resin is measured according to JIS K1557-1970. A specific measuring method will be described below.

A pulverized product of a sample is accurately weighed out in about 2 g (W (g)). The sample is put in a 200 ml conical flask, and a mixture solution of toluene/ethanol (2:1) (100 ml) is added thereto. After the sample is dissolved for 5 hours, a phenolphthalein solution as an indicator is added thereto.

With a burette, the above solution is titrated with a 0.1 N potassium hydroxide alcoholic solution. As a result, the amount of the KOH solution is S (ml). A blank test is performed, and the amount of the KOH solution is B (ml).

The acid value is calculated according to the formula below.

Acid Value=[(S−B)×f×5.61]/W

(f: factor of the KOH solution)

(Longer Side and Coverage of Protrusions)

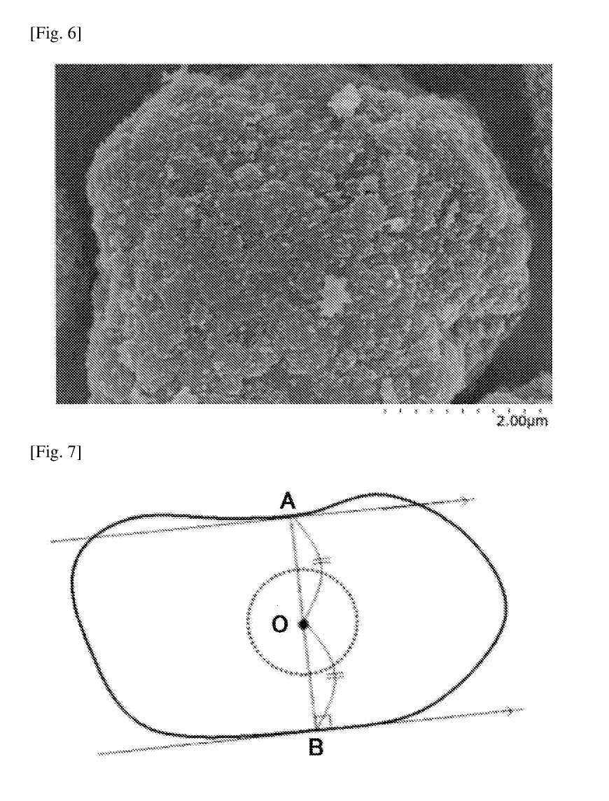

The toner is observed with a scanning electron microscope (SEM). From an obtained SEM image, the length of the longer side of the protrusions and a coverage by the protrusions over a toner particle are calculated. FIG. 6 is a SEM image of an example of a toner used in the present invention. FIG. 7 is a diagram explaining the method for calculating the coverage by the protrusions over a toner particle.

The method for calculating the longer side of the protrusions and the coverage described in Examples will be described below.

As for the coverage, the distance between two parallel lines, the distance between which is the shortest among any two parallel lines that contact a toner particle, is calculated, and the contact points at which the two parallel lines contact the toner particle are referred to as A and B, respectively. The coverage by the protrusions over the toner particle is calculated based on the area of a circle centered at the median O of a line segment AB and having a diameter corresponding to the length of the line segment AO, and the area of protrusions included in the circle.

The coverage is calculated according to the above method for a hundred or more toner particles, and an average coverage is calculated. An average length of the longer side is calculated by measuring the length of the longer side of a hundred or more protrusions from one or more toner particles. The area of the protrusions, the longer side of the protrusions, and the circularity are measured with image-analyzing granularity distribution measurement software “MAC-VIEW” (manufactured by Mountech Co., Ltd.). The method for measuring the length of the longer side of the protrusions and the area of the protrusions is not particularly limited, and an arbitrary method may be selected according to the purpose.

The average length of the longer side of the protrusions is 0.1 μm or greater, and 0.5 μm or less, preferably 0.3 μm or less. When the average length is greater than 0.5 μm, the protrusions on the surface are sparse, leading to a small surface area and a small number of external additive particles to be supported firmly, which is unfavorable. The standard deviation of the average length is 0.2 or less, and preferably 0.1 or less. When the standard deviation is greater than 0.2, the size of the protrusions on the surface is non-uniform, and surface area enlargement cannot be expected, which is unfavorable. The coverage is from 30% to 90%, preferably from 40% to 80%, and more preferably from 50% to 70%. When the coverage is less than 30% or greater than 90%, the number of external additive particles to be supported firmly is small, which is unfavorable.

(Measurement of Charge Buildup Amount)

Measurement is performed with a blow-off device described in Japanese Patent (JP-B) No. 3487464. A carrier (25 g) for IMAGIO NEO C600 manufactured by Ricoh Company, Ltd., and a sample (0.05 g) are put in a poly bottle, and mixed with a roll mill for 5 minutes. After this, the mixture (2.0 g) is picked and introduced into the blow-off device.

<Image Forming Apparatus, Process Cartridge, and Image Forming Method>

An image forming apparatus of the present invention may be constituted by assembling such constituent members as a photoconductor, a developing unit, a cleaning unit, etc. in the form of a process cartridge, such that the process cartridge can be mounted on and demounted from the body of the image forming apparatus as needed. Further, at least one of a charging unit, an exposure unit, a developing unit, a transfer unit, a separating unit, and a cleaning unit may be supported together with a photoconductor to thereby form a process cartridge and constitute a single unit, which can be mounted on and demounted from the body of the image forming apparatus as needed, and may be mounted and demounted as needed by means of a guide unit such as a rail in the body of the image forming apparatus.

### EXAMPLES

The present invention will be described below in detailed by raising Examples. However, the present invention is not limited to Examples shown below. “Part” represents “part by mass”, unless otherwise expressly specified. “%” represents “% by mass”, unless otherwise expressly specified.

### Production Examples 1 to 9

<Blade Adjustment>

As for the cleaning blade, the elastic-body blade made of polyurethane was immersed in an isocyanate-based treatment liquid to adjust the surface friction coefficient and the surface elastic modulus.

Specifically, the elastic-body blade made of polyurethane was immersed and adequately refined in a treatment liquid obtained by dissolving in a solvent, at least one that was selected from the group consisting of a fluorine-based polymer and a silicon-based polymer and that was added to an isocyanate component. Elastic-body blades having the physical properties shown in Table 1 below were produced by changing the additive amounts of the isocyanate component, the fluorine-based polymer, and the silicon-based polymer to thereby change the concentration of the treatment liquid.

TABLE 1

| Surface | | | | | |
|---|---|---|---|---|---|
| elastic | Surface friction coefficient | | | | |
| modulus | 0.4 | 0.5 | 0.6 | 0.7 | 0.8 |
| 10 | Production | — | — | — | Production |
| | Ex. 6 | | | | Ex. 7 |
| 15 | — | Production | — | Production | — |
| | | Ex. 1 | | Ex. 2 | |
| 20 | — | — | Production | — | — |
| | | | Ex. 3 | | |
| 25 | — | Production | — | Production | — |
| | | Ex. 4 | | Ex. 5 | |
| 30 | Production | — | — | — | Production |
| | Ex. 8 | | | | Ex. 9 |

The unit of the surface elastic modulus is N/mm².

˜Production of Toner˜

<Method for Producing Resin Dispersion 1>

Sodium dodecyl sulfate (0.7 parts) and ion-exchanged water (498 parts) were put in a reaction container equipped with a cooling tube, a stirrer, and a nitrogen introducing tube, heated to 80° C. while being stirred, and dissolved. Then, potassium persulfate (2.6 parts) dissolved in ion-exchanged water (104 parts) was added thereto. Fifteen minutes later, a mixed-monomer liquid of styrene monomer (170 parts), butyl acrylate (30 parts), and n-octanethiol (8.2 parts) was dropped thereto in 90 minutes. The resultant was maintained at 80° C. for 60 minutes, to be allowed to undergo a polymerization reaction.

After this, the resultant was cooled, to thereby obtain a white <Resin Dispersion 1> having a volume average particle diameter of 53.2 nm. The obtained <Resin Dispersion 1> (2 ml) was taken in a petri dish, the dispersion medium was vaporized, and the obtained dry solid product was measured. As a result, the dry solid product had a number average molecular weight of 5,400, a weight average molecular weight of 9,800, and Tg of 49.4° C.

<Synthesis of Polyester 1>

Bisphenol A-ethylene oxide 2 mol adduct (229 parts), bisphenol A-propion oxide 3 mol adduct (529 parts), terephthalic acid (208 parts), adipic acid (46 parts), and dibutyl tin oxide (2 parts) were put in a reaction tank equipped with a cooling tube, a stirrer, and a nitrogen introducing tube, and reacted at normal pressure at 230° C. for 8 hours. Next, they were reacted at a reduced pressure of from 10 mmHg to 15 mmHg for 5 hours. After this, trimellitic anhydride (44 parts) was added to the reaction tank, and they were reacted at normal pressure at 180° C. for 2 hours, to thereby synthesize <Polyester 1>. The obtained <Polyester 1> had a number average molecular weight of 2,500, a weight average molecular weight of 6,700, a glass transition temperature of 43° C., and an acid value of 25 mgKOH/g.

<Synthesis of Polyester 2>

Bisphenol A-ethylene oxide 2 mol adduct (264 parts), bisphenol A-propylene oxide 2 mol adduct (523 parts), terephthalic acid (123 parts), adipic acid (173 parts), and dibutyl tin oxide (1 part) were put in a reaction container equipped with a cooling tube, a stirrer, and a nitrogen introducing tube, and reacted at normal pressure at 230° C. for 8 hours. They were further reacted at a reduced pressure of from 10 mmHg to 15 mmHg for 8 hours. After this, trimellitic anhydride (26 parts) was added to the reaction container, and they were reacted at 180° C. at normal pressure for 2 hours, to thereby obtain <Polyester 2>. <Polyester 2> had a number average molecular weight of 4,000, a weight average molecular weight of 47,000, a glass transition temperature of 65° C., and an acid value of 12.

<Synthesis of Isocyanate-Modified Polyester 1>

Bisphenol A-ethylene oxide 2 mol adduct (682 parts), bisphenol A-propylene oxide 2 mol adduct (81 parts), terephthalic acid (283 parts), trimellitic anhydride (22 parts), and dibutyl tin oxide (2 parts) were put in a reaction container equipped with a cooling tube, a stirrer, and a nitrogen introducing tube, and reacted at normal pressure at 230° C. for 8 hours. Next, they were reacted at a reduced pressure of from 10 mmHg to 15 mmHg for 5 hours, to thereby synthesize <Intermediate Polyester 1>. The obtained <Intermediate Polyester 1> had a number average molecular weight of 2,200, a weight average molecular weight of 9,700, a glass transition temperature of 54° C., an acid value of 0.5 mgKOH/g, and a hydroxyl value of 52 mgKOH/g.

Next, <Intermediate Polyester 1> (410 parts), isophorone diisocyanate (89 parts), and ethyl acetate (500 parts) were put in a reaction container equipped with a cooling tube, a stirrer, and a nitrogen introducing tube, and reacted at 100° C. for 5 hours, to thereby obtain <Isocyanate-Modified Polyester 1>.

<Production of Master Batch>

Carbon black (REGAL 400R manufactured by Cabot Corporation) (40 parts), a binder resin: polyester resin (RS-801 manufactured by Sanyo Chemical Industries, Ltd., with an acid value of 10, Mw of 20,000, and Tg of 64° C.) (60 parts), and water (30 parts) were mixed with a Henschel mixer, to thereby obtain a mixture of pigment aggregates soaked with water. This was kneaded with two rolls set to a roll surface temperature of 130° C. for 45 minutes, and pulverized with a pulverizer to a size of 1 mm, to thereby obtain <Master Batch 1>.

<Oil Phase Producing Step>

<Polyester 1> (545 parts), <Paraffin Wax (with a melting point of 74° C.)> (181 parts), and ethyl acetate (1,450 parts) were put in a container fitted with a stirring bar and a thermometer, heated to 80° C. while being stirred, maintained at 80° C. for 5 hours, and cooled to 30° C. in 1 hour. Then, <Master Batch 1> (500 parts), and ethyl acetate (100 parts) were put in the container, and they were mixed for 1 hour, to thereby obtain <Material Dissolved Liquid 1>.

<Material Dissolved Liquid 1> (1,500 parts) was removed to another container, and subjected to a bead mill (ULTRAVISCO MILL manufactured by Aimex Corporation) at a liquid delivering rate of 1 kg/hr, at a disk peripheral velocity of 6 m/second, with zirconia beads packed to 80% by volume, and for 3 passes, to disperse the pigment and the wax. Next, a 66% ethyl acetate solution (655 parts) of <Polyester 2> was added thereto, and subjected to the bead mill under the conditions described above for 1 pass, to thereby obtain <Pigment/Wax Dispersion Liquid 1>.

<Pigment/Wax Dispersion Liquid 1> (976 parts) was mixed with a TK homomixer (manufactured by Primix Corporation) at 5,000 rpm for 1 minute,

<Isocyanate-Modified Polyester 1> (88 parts) was added thereto, and they were mixed with a TK homomixer (manufactured by Primix Corporation) at 5,000 rpm for 1 minute, to thereby obtain <Oil Phase 1>. The solid component of <Oil Phase 1> measured 52.0% by mass, and the amount of ethyl acetate relative to the solid component was 92% by mass.

<Preparation of Aqueous Phase>

Ion-exchanged water (970 parts), a 25% by mass aqueous dispersion liquid (40 parts) of organic resin particles for a dispersion stabilization purpose (a copolymer of styrene/methacrylic acid/butyl acrylate/sodium salt of methacrylic acid-ethylene oxide adduct sulfate ester), a 48.5% aqueous solution (95 parts) of sodium dodecyl diphenyl ether disulfonate, and ethyl acetate (98 parts) were mixed and stirred, resulting in pH of 6.2. A 10% sodium hydroxide aqueous solution was dropped thereto to adjust the pH to 9.5, to thereby obtain <Aqueous Phase 1>.

<Core Particle Producing Step>

<Aqueous Phase 1> (1,200 parts) was added to the obtained <Oil Phase 1>, and they were mixed with a TK homomixer at a rotation speed adjusted in the range of from 8,000 rpm to 15,000 rpm for 2 minutes while the internal temperature of the liquid was adjusted in the range of from 20° C. to 23° C. by cooling in a water bath in order to suppress temperature rise due to a shearing heat of the mixer. After this, they were stirred with a three-one motor fitted with an anchor blade at a rotation speed adjusted in the range of from 130 rpm to 350 rpm for 10 minutes, to thereby obtain <Core Particle Slurry 1> in which oil phase liquid droplets to be the core particles were dispersed in the aqueous phase.

<Formation of Protrusions>

A mixture of <Resin Dispersion 1> (106 parts) and ion-exchanged water (71 parts) (the mixture having a solid component concentration of 15%) was dropped in 3 minutes while being maintained at a liquid temperature of 22° C. to <Core Particle Slurry 1>, while <Core Particle Slurry 1> was stirred with a three-one motor fitted with an anchor blade at a rotation speed adjusted in the range of from 130 rpm to 350 rpm. After the dropping, they were stirred at a rotation speed adjusted in the range of from 200 rpm to 450 rpm for 30 minutes, to thereby obtain <Composite Particle Slurry 1>. <Composite Particle Slurry 1> (1 ml) was diluted to 10 ml, and subjected to centrifugal separation. As a result, the supernatant liquid was transparent.

<Desolventization>

<Composite Particle Slurry 1> was put in a container fitted with a stirrer and a thermometer, and desolventized at 30° C. for 8 hours while being stirred, to thereby obtain <Dispersed Slurry 1>. A small amount of <Dispersed Slurry 1> was put over a glass slide, and observed through a cover glass with an optical microscope at a magnification of ×200. As a result, uniform colored particles were observed. Further, <Dispersed Slurry 1> (1 ml) was diluted to 10 ml, and subjected to centrifugal separation. As a result, the supernatant liquid was transparent.

<Washing/Drying Step>

After <Dispersed Slurry 1> (100 parts) were filtered at reduced pressure,

(1): Ion-exchanged water (100 parts) was added to the obtained filtration cake, and they were mixed with a TK homomixer (at a rotation speed of 12,000 rpm for 10 minutes), and then filtered.

(2): Ion-exchanged water (900 parts) was added to the filtration cake of (1), and they were mixed with a TK homomixer (at a rotation speed of 12,000 rpm for 30 minutes) with application of ultrasonic vibrations, and then filtered at reduced pressure. This operation was repeated such that the electric conductivity of the reslurry liquid would become equal to or less than 10 μC/cm.

(3): A 10% hydrochloric acid was added to the reslurry liquid of (2) to adjust the pH thereof to 4, and the resultant was stirred with a three-one motor and then filtered.

(4): Ion-exchanged water (100 parts) was added to the filtration cake of (3), and they were mixed with a TK homomixer (at a rotation speed of 12,000 rpm for 10 minutes), and then filtered. This operation was repeated such that the electric conductivity of the reslurry liquid would become equal to or less than 10 μC/cm, to thereby obtain <Filtration Cake 1>.

<Filtration Cake 1> was dried with a circulating air dryer at 45° C. for 48 hours, and sieved through a mesh having a mesh size of 75 μm, to thereby obtain <Toner Base 1>. The obtained <Toner Base 1> was observed with a scanning electron microscope. As a result, a vinyl-resin attached to the surface of the core particles uniformly.

RX200 (manufactured by Nippon Aerosil Co., Ltd., a number average particle diameter of primary particles: 12 nm) was added to <Toner Base 1> (100 parts), to thereby obtain a toner. The additive amount of the external additives was as described in Table 2 below. The toners used in the respective Examples and respective Comparative Examples were the same, except that the additive amount of the external additives were varied. That is, the toner base was Toner Base 1 in any example.

### Production Example 10

<Blade Adjustment>

As a cleaning blade of Production Example 10, an elastic-body blade described in JP-A No. 2010-210879 in Example 2 was used as it was. That is, the elastic-body blade of Production Example 10 was as follows.

Urethane Rubber

Urethane rubber having a hardness of 69°, and an impact resilience of 49% (manufactured by Toyo Tire & Rubber Co., Ltd.) The hardness of the urethane rubber was measured with a durometer manufactured by Shimadzu Corporation according to JIS K6253. The sample was a laminate having a thickness of 6 [mm] or greater obtained by overlaying sheets having a thickness of about 2 [mm].

The impact resilience of the urethane rubber was measured with NO. 221 RESILIENCE TESTER manufactured by Toyo Seiki Seisaku-Sho, Ltd. according to JIS K6255. The sample was a laminate having a thickness of 4 [mm] or greater obtained by overlaying sheets having a thickness of about 2 [mm].

Impregnation Liquid

Isocyanate compound: MR-100 manufactured by Nippon Polyurethane Industry Co., Ltd. (10 parts by mass)

Silicon resin: MODIPER FS-700 manufactured by NOF Corporation (2 parts by mass)

2-butanone: (88 parts by mass)

Surface Layer

Urethane acrylate oligomer 1: UN-904 manufactured by Negami Chemical Industrial Co., Ltd. (5 parts by mass)

Urethane acrylate oligomer 2: UN-2700 manufactured by Negami Chemical Industrial Co., Ltd. (19.5 parts by mass)

Low friction coefficient additive: COPOLYMER A1 manufactured by Chisso Petrochemical Corporation (5 parts by mass)

Polymerization initiator: IRGACURE 184 manufactured by Ciba Specialty Chemicals Corporation (1 part by mass)

Solvent: 2-butanone (74 parts by mass)

Coating film hardness: pencil hardness H

Friction coefficient: 0.1

Surface elastic modulus: 30 N/mm²

Surface friction coefficient: 0.35

A pencil hardness of the surface layer was measured with a pencil scratching tester KTVF-2380 manufactured by Cotec Corporation according to JIS K5600-5-4. The sample was a 50 [mm]×50 [mm] glass plate spray-coated with the materials of the surface layer to a thickness of about 10 [μm].

As a friction coefficient of the surface layer (a surface friction coefficient thereof was as described above), a maximum static friction coefficient was measured with TRIBOGEAR MUSE 941 manufactured by Shinto Scientific Co., Ltd. The sample was a 50 [mm]×50 [mm] glass plate spray-coated with the coating materials to a thickness of about 10 [μm].

(Evaluation)

A paper passing test was performed by setting the toners and cleaning blades described above in the process cartridge of IPSIO SPC730 manufactured by Ricoh Company, Ltd.

An image with an image printing rate of 2% was generated and output on A4 sheets that were passed in parallel with their longer direction, at a pace of one sheet in every 20 seconds, under conditions changed from 23°/50% to 27°/80% to 10°/15% to 27°/80%, up to 3,000 sheets per color totaling to 12,000 sheets.

After the sheets were passed, images were output on A4 sheets on their full surface by a halftone manner, and defective image evaluation was performed based on fiverank classification of longer-direction streaks on the images due to cleaning failures or filming over the photoconductor. A filming halftone streak that was rank 4 or higher would not be a streak defect that would be perceived on the image, and was hence judged to be a pass. A filming halftone streak that was rank 3 or lower was judged to be a reject.

Furthermore, the apparatus was forcibly suspended while an A4 sheet carrying a white image was passed, and a transparent tape was pasted over the photoconductor to collect any background smear toner over the photoconductor. The tape with the collected toner was pasted on a white sheet (TYPE 6000 manufactured by Ricoh Company, Ltd.), and the luminosity of the pasted toner was measured from above with a hue color difference meter (manufactured by X-Rite, Incorporated.), to thereby quantify the background smear toner over the photoconductor and evaluate the amount of the background smear toner. A lower amount of background smear toner would indicate a lower amount of toner that had been used for other than image formation, which is favorable because the consumption efficiency would be improved. However, as a system, as long as the luminosity (L*) is 89 or higher, it is allowed to judge that the amount of toner loaded is sufficient to satisfy the life span requirement, which is the criterion to make a judgment of “pass”.

The results of the evaluations described above are shown in Table 2 below. The figures in the background smear field are luminosity (L*) values.

TABLE 2

| | | | Surface | | Toner external | Filming | |
|---|---|---|---|---|---|---|---|
| | Cleaning | Rubber | elastic | Friction | additive | halftone | Bg. |
| | blade | hardness | modulus | coefficient | amount | streak | smear |
| Comp. Ex. 1-1 | Production | 74 | 15 | 0.5 | 3.5 | 5 | 87 |
| Ex. 1-1 | Ex. 1 | 74 | 15 | 0.5 | 4 | 5 | 89 |
| Ex. 1-2 | | 74 | 15 | 0.5 | 5.5 | 5 | 90 |
| Ex. 1-3 | | 74 | 15 | 0.5 | 7 | 4 | 91 |
| Comp. Ex. 1-2 | | 74 | 15 | 0.5 | 7.5 | 3 | 91 |
| Comp. Ex. 2-1 | Production | 74 | 15 | 0.7 | 3.5 | 5 | 87 |
| Ex. 2-1 | Ex. 2 | 74 | 15 | 0.7 | 4 | 4 | 89 |
| Ex. 2-2 | | 74 | 15 | 0.7 | 5.5 | 4 | 90 |
| Ex. 2-3 | | 74 | 15 | 0.7 | 7 | 4 | 91 |
| Comp. Ex. 2-2 | | 74 | 15 | 0.7 | 7.5 | 3 | 91 |
| Comp. Ex. 3-1 | Production | 78 | 20 | 0.6 | 3.5 | 5 | 87 |
| Ex. 3-1 | Ex. 3 | 78 | 20 | 0.6 | 4 | 5 | 89 |
| Ex. 3-2 | | 78 | 20 | 0.6 | 5.5 | 5 | 90 |
| Ex. 3-3 | | 78 | 20 | 0.6 | 7 | 4 | 91 |
| Comp. Ex. 3-2 | | 78 | 20 | 0.6 | 7.5 | 3 | 91 |
| Comp. Ex. 4-1 | Production | 80 | 25 | 0.5 | 3.5 | 5 | 87 |
| Ex. 4-1 | Ex. 4 | 80 | 25 | 0.5 | 4 | 5 | 89 |
| Ex. 4-2 | | 80 | 25 | 0.5 | 5.5 | 5 | 90 |
| Ex. 4-3 | | 80 | 25 | 0.5 | 7 | 5 | 91 |
| Comp. Ex. 4-2 | | 80 | 25 | 0.5 | 7.5 | 2 | 91 |
| Comp. Ex. 5-1 | Production | 80 | 25 | 0.7 | 3.5 | 5 | 87 |
| Ex. 5-1 | Ex. 5 | 80 | 25 | 0.7 | 4 | 5 | 89 |
| Ex. 5-2 | | 80 | 25 | 0.7 | 5.5 | 5 | 90 |
| Ex. 5-3 | | 80 | 25 | 0.7 | 7 | 4 | 91 |
| Comp. Ex. 5-2 | | 80 | 25 | 0.7 | 7.5 | 2 | 91 |
| Comp. Ex. 6-1 | Production | 69 | 10 | 0.4 | 3.5 | 3 | 87 |
| Comp. Ex. 6-2 | Ex. 6 | 69 | 10 | 0.4 | 4 | 3 | 89 |
| Comp. Ex. 6-3 | | 69 | 10 | 0.4 | 5.5 | 3 | 90 |
| Comp. Ex. 6-4 | | 69 | 10 | 0.4 | 7 | 2 | 91 |
| Comp. Ex. 6-5 | | 69 | 10 | 0.4 | 7.5 | 2 | 91 |
| Comp. Ex. 7-1 | Production | 72 | 10 | 0.4 | 3.5 | 3 | 87 |
| Comp. Ex. 7-2 | Ex. 7 | 72 | 10 | 0.8 | 4 | 3 | 89 |
| Comp. Ex. 7-3 | | 72 | 10 | 0.8 | 5.5 | 2 | 90 |
| Comp. Ex. 7-4 | | 72 | 10 | 0.8 | 7 | 2 | 91 |
| Comp. Ex. 7-5 | | 72 | 10 | 0.8 | 7.5 | 2 | 91 |
| Comp. Ex. 8-1 | Production | 83 | 30 | 0.4 | 3.5 | 2 | 87 |
| Comp. Ex. 8-2 | Ex. 8 | 83 | 30 | 0.4 | 4 | 2 | 89 |
| Comp. Ex. 8-3 | | 83 | 30 | 0.4 | 5.5 | 1 | 90 |
| Comp. Ex. 8-4 | | 83 | 30 | 0.4 | 7 | 1 | 91 |
| Comp. Ex. 8-5 | | 83 | 30 | 0.4 | 7.5 | 1 | 91 |
| Comp. Ex. 9-1 | Production | 80 | 30 | 0.8 | 3.5 | 2 | 87 |
| Comp. Ex. 9-2 | Ex. 9 | 80 | 30 | 0.8 | 4 | 1 | 89 |
| Comp. Ex. 9-3 | | 80 | 30 | 0.8 | 5.5 | 1 | 90 |
| Comp. Ex. 9-4 | | 80 | 30 | 0.8 | 7 | 1 | 91 |
| Comp. Ex. 9-5 | | 80 | 30 | 0.8 | 7.5 | 1 | 91 |
| Comp. Ex. 10-1 | Production | 69 | 30 | 0.35 | 3.5 | 2 | 87 |
| Comp. Ex. 10-2 | Ex. 10 | 69 | 30 | 0.35 | 4 | 1 | 89 |
| Comp. Ex. 10-3 | | 69 | 30 | 0.35 | 5.5 | 1 | 90 |
| Comp. Ex. 10-4 | | 69 | 30 | 0.35 | 7 | 1 | 91 |
| Comp. Ex. 10-5 | | 69 | 30 | 0.35 | 7.5 | 1 | 91 |

In Table 2, the unit of the surface elastic modulus is N/mm². Toner external additive amount represents an amount of external additives (part by mass) relative to 100 parts by mass of base particles in the toner.

The followings were revealed from Examples and Comparative Examples, and Table 2 above.

When the amount of external additives was higher, the charge buildup amount of the toner was higher, and the amount of toner that became the component of background smear (i.e., adhesion of reversely-charged toner to the photoconductor) was lower, with a better consumption efficiency. However, the external additives had a very small particle diameter, and a cleaning blade could not have a sufficient ability to inhibit their passing through. Therefore, with a cleaning blade that was not within the range of prescription of the present invention, a streak was produced on an image due to slip-through of the external additives and their filming over the photoconductor. With a lower elastic modulus, the ability to scrape off the surface of the photoconductor was poorer, which resulted in a larger amount of slip-through. On the other hand, with a higher elastic modulus, the leading end of the blade deformed by following the surface of the photoconductor while the photoconductor was rotating, but had a poor resilience and reduced the ability to follow the surface of the photoconductor, which produced a slight gap between the blade and the photoconductor to worsen the slip-through.

With a lower friction coefficient, the ability to inhibit slip-through was higher, because the behavior of the leading end of the blade was more moderate.

Hence, it turned out that the present invention could provide an image forming apparatus that that could provide high-quality images by suppressing cleaning failures under various conditions of use.

### REFERENCE SIGNS LIST

1 photoconductor
2 charging device
3 light exposure
4 toner supply container
5 developing device
7 transfer device
9 fixing device
11 elastic-body blade
12 cleaning device
13 transfer belt
15 sensor
16 transfer belt cleaning device
17 cleaning facing roller
18 collecting roller
19 leading end surface
30 stirring paddle
31 toner storing container
32 conveying unit
33 developing device
34 divider plate
35 opening portion
36 opening portion
37 first toner conveying unit
38 second toner conveying unit
39 drive transmission unit
40 toner supply member
41 developing member
42 regulating member
43 photoconductor drum
44 cleaning unit

1. An image forming apparatus, comprising:
an image bearer;
a charging unit configured to electrically charge a surface of the image bearer;
a developing unit configured to develop with a toner, an electrostatic latent image formed over the image bearer by an exposure unit configured to perform light exposure;
a transfer unit configured to transfer the developed toner to a receiving member; and
a cleaning unit configured to clean a residual toner of the toner remaining over the image bearer without being transferred,
wherein the toner comprises: one or more external additives; and base particles made of at least a binder resin and a colorant,
wherein a content of the one or more external additives in the toner is from 4 parts by mass to 7 parts by mass relative to 100 parts by mass of the base particles,
wherein primary particles of at least one of the one or more external additives have a number average particle diameter of from 0.01 μm to 0.05 μm,
wherein the cleaning unit comprises an elastic-body blade, and
wherein the elastic-body blade has a surface elastic modulus of from 15 N/mm² to 25 N/mm² and a surface friction coefficient of from 0.5 to 0.7 at an abutment part thereof abutting on the image bearer.

2. The image forming apparatus according to claim 1,
wherein the elastic-body blade is obtained by immersing a polyurethane material in an isocyanate-based treatment liquid.

3. The image forming apparatus according to claim 1,
wherein at a position at which a leading end of the elastic-body blade abuts on the image bearer, an angle formed between a tangent line on the surface of the image bearer in a direction of rotation and a cut surface of the elastic-body blade is from 77° to 82°.

4. The image forming apparatus according to claim 1,
wherein a linear pressure of the elastic-body blade on the image bearer is from 30 N/m to 70 N/m.

5. The image forming apparatus according to claim 1,
wherein the elastic-body blade has a JIS-A hardness of from 76 to 82.

6. The image forming apparatus according to claim 1,
wherein a content, in the toner, of the at least one of the one or more external additives, of which primary particles have the number average particle diameter of from 0.01 μm to 0.05 μm, is from 1.0 part by mass to 2.5 parts by mass relative to 100 parts by mass of the base particles.

7. The image forming apparatus according to claim 1,
wherein the one or more external additives are hydrophobized silica particles.

8. A process cartridge, comprising:
an image bearer;
one or more selected from the group consisting of a charging unit configured to electrically charge a surface of the image bearer, a developing unit configured to develop with a toner, an electrostatic latent image formed over the image bearer by an exposure unit configured to perform light exposure, and a transfer unit configured to transfer the developed toner to a receiving member; and
a cleaning unit configured to clean a residual toner of the toner remaining over the image bearer without being transferred,
wherein the toner comprises: one or more external additives; and base particles made of at least a binder resin and a colorant,
wherein a content of the one or more external additives in the toner is from 4 parts by mass to 7 parts by mass relative to 100 parts by mass of the base particles,
wherein primary particles of at least one of the one or more external additives have a number average particle diameter of from 0.01 μm to 0.05 μm,
wherein the cleaning unit comprises an elastic-body blade, and
wherein the elastic-body blade has a surface elastic modulus of from 15 N/mm² to 25 N/mm² and a surface friction coefficient of from 0.5 to 0.7 at an abutment part thereof abutting on the image bearer.

9. The process cartridge according to claim 8,
wherein the elastic-body blade is obtained by immersing a polyurethane material in an isocyanate-based treatment liquid.

10. The process cartridge according to claim 8,
wherein at a position at which a leading end of the elastic-body blade abuts on the image bearer, an angle formed between a tangent line on the surface of the image bearer in a direction of rotation and a cut surface of the elastic-body blade is from 77° to 82°.

11. The process cartridge according to claim 8,
wherein a linear pressure of the elastic-body blade on the image bearer is from 30 N/m to 70 N/m.

12. The process cartridge according to claim 8,
wherein the elastic-body blade has a JIS-A hardness of from 76 to 82.

13. The process cartridge according to claim 8,
wherein a content, in the toner, of the at least one of the one or more external additives, of which primary particles have the number average particle diameter of from 0.01 μm to 0.05 μm, is from 1.0 part by mass to 2.5 parts by mass relative to 100 parts by mass of the base particles.

14. The process cartridge according to claim 8,
wherein the one or more external additives are hydrophobized silica particles.
